(19) United States
(12) Patent Application Publication
(10) Pub. No.: US 2015/0026159 A1
(43) Pub. Date: Jan. 22, 2015

(54) Digital Resource Set Integration Methods, Interfaces and Outputs

(71) Applicant: EVRESEARCH LTD, Columbus, OH (US)

(72) Inventor: Paul Arthur Berkman, Cambridge (GB)

(73) Assignee: EVRESEARCH LTD, Columbus, OH (US)

(21) Appl. No.: 14/383,264

(22) PCT Filed: Mar. 5, 2013
(86) PCT No.: PCT/US2013/029010

§ 371 Date: Sep. 5, 2014

Related U.S. Application Data
(60) Provisional application No. 61/606,768, filed on Mar. 5, 2012.

(51) Int. Cl. G06F 17/30

(52) U.S. Cl. CPC G06F 17/30554; G06F 17/30572; G06F 17/30477
USPC 707/722

(57) ABSTRACT

Retrieving information from an informational resource is described. A system can include: a computer processor(s); display device(s) operatively coupled with the processor(s); searchable database(s) including at least a portion of an informational resource broken into a plurality of discrete finite elements and a respective plurality of categorical tags respectively describing content for each of the plurality of discrete finite elements, where the informational resource includes at least three levels of granularity for the information, from a shallow level of granularity to a deep level of granularity. A search querry can be executed and the corresponding results displayed based on a requested level of granularity.

### CROSS REFERENCE TO RELATED APPLICATIONS

The current application claims the benefit of U.S. Provisional Application, No. 61/606,768, filed Mar. 5, 2012, the disclosure of which is incorporated herein by reference.

### BACKGROUND

Current digital information management, retrieval, display and analysis are fundamentally limited by the ubiquitous approaches to “structured” versus “unstructured” resources. Structured information resources are operated with databases, metadata, markup, semantics and ontologies to search and retrieve of information in relational schema from linear lists to multi-dimensional displays and statistical representations. By convention, unstructured resources cannot be automatically decomposed into relational schema without imposing database, metadata, markup, semantic or ontology solutions. However, the meaning of information is revealed by the content, context and structure of the resources, which means that there is no such thing as unstructured information only information that is unmanaged with conventional solutions. This invention applies to all digital resources, as envisioned for ‘Big Data,’ which is simply defined herein as the combination of digital resources that have conventionally been described as structured and unstructured.

With hardcopy formats, from stone to paper, resources were managed in their entirety through library (content) and archive (context) architectures because it was not possible to utilize their inherent structures to manage subsets of the parent resources. The management, retrieval and display limitation of hardcopy resources has been that their structure could not be used to break the parent resources into subsets of children, grandchildren and other levels of information granularity down to finite elements. Consequently, with hardcopy formats, subsets of the parent resources could neither be searched nor retrieved independently. Moreover, with hardcopy formats, subsets of the parent resources could not be integrated independently into relational schema. These information management, retrieval, display and analysis limitations of hardcopy resources have been artificially imposed on digital resources. Implications of these fundamental limitations run across the entire business spectrum of what currently is considered to be ‘Big Data.’

For example, an inherent drawback in many conventional search engines or search tools is that the results of the search are typically organized into lists, which are generated from linear inverted indexes. Moreover, the listing of resources involves ranking by subjective algorithms, such as perceived relevance of the resources or the number of hits that the search word or phrase has in that resource (e.g., Web page) that is being searched. This linear type of search result provides access to the resources, but without revealing the inherent relationships that exist within and between the different resources.

Further, if the search term is not indexed (as may occur with metadata, semantic or ontology solutions), the necessary resources will be inaccessible. For certain types of digital resources, such as natural language files in particular, metadata can be considered to be redundant since the files themselves contain the information content that would otherwise be described subjectively in the various metadata fields. There is additional complexity and subjectivity with metadata, semantic indexes or ontologies extending across different languages.

In addition, linear results merely indicate that the search term or phrase exists at least once in each retrieved resource without any information about the number of search term or phrase instances or locations in each resource. Consequently, the end user must go through the search results in a list one by one to sequentially identify each instance of the search term or phrase in each retrieved resource. The user then has the burden to cut and past the desired pieces from each resource into a repository of pieces. The user is further burdened with organizing the repository of pieces, generally in a subjective manner. Such subjectivity is compounded from the search and display algorithms, which are constrained generally by software engineers and programmers on behalf of user communities.

Thus, there is a need for digital integration methodologies and tools that empower the user to quickly discover, interpret and analyze relationships within and between diverse digital resources with objectivity.

### SUMMARY

The present disclosure embodies methods and interfaces to integrate a set of one or more digital resources into a plurality of relational displays that are linked across embedded levels of granularity that can be output into statistical formats. The present disclosure involves the next generation of computerized systems and methods for searching, retrieving, displaying and analyzing information from information and concept spaces; and more particularly, the present disclosure builds on information management, retrieval and display systems and methods for searching through an informational resource and for displaying the results of the search in collapsible/expandable formats based upon a user-selected display criteria or hierarchies.

The present disclosure embodies methods and interfaces to integrate a set of one or more digital resources into a plurality of relational displays that are linked across embedded levels of granularity that can be output into statistical formats. The present disclosure involves computerized systems and methods for searching, retrieving, displaying, integrating and analyzing information from diverse information and concept spaces, including: an individual text resource (e.g., a book, report, email message, treaty); a set of text resources (e.g. Web pages resident on the Internet, a digital library, a digital archive, an email repository); a set of text resources in multiple languages with different symbologies (e.g., English, Chinese, Arabic, Hindi); an individual database of alpha-numeric values (e.g., a spreadsheet); a set of databases with alpha-numeric values (e.g., multiple spreadsheets, transactional data from a business); a stream of information (e.g., satellite data transmissions, social media feeds); an individual image (e.g., a photograph, a a chart, an electrophoretic assay); a set of images (e.g., photographs stored on a camera; multiple assays); a set of symbols (e.g., a DNA sequence); mixtures of different types of resource sets (e.g., photographs mixed with texts in different languages; texts in different languages mixed with transactional data). The contents, type or format of the informational resource set is not critical.

An exemplary embodiment of the current disclosure includes six modules that operate together or independently on a resource or set of resources: a granularity (break) module, an index module, a search module, an integration module, an aggregation (un-break) module; and an analytics module. The starting operation is any relational question defined by a user, who requires knowledge to be discovered beyond known facts (e.g., such as “what is a Borromean ring?” or “how far is Jupiter from Earth”), pre-existing databases or relational schema constrained by programmers. With the question, the user then may select the resource or set of resources to integrate by applying the five modules.

The granularity module may be an expert system operating upon a set of expert rules that define its operation. The granularity module parses through the resource or set of resources to break them into organizational levels that are defined by their structure (such as sentences embedded within paragraphs within pages within chapters within books within years). The lowest level of granularity is the finite element, which ultimately could be an ASCII character in a text document, a pixel in an image or an amino acid in a protein sequence. Structure of the resources can be demarcated by content boundaries (e.g., punctuation, amino acid codons, time stamps,) and patterns (e.g., numeric thresholds, content segments bounded by white space, grammatical standards).

It is envisioned that the rule sets will be created and refined by an expert on the resource or set of resources to be integrated. For example, experts could be; chefs or homemakers who are familiar with a set of cookbooks and recipes; legal experts who are familiar with set of laws and regulations; scientists who are familiar with different types of sensor data; biochemists and geneticists who are familiar with amino acid sequences and genomes; business professionals who are familiar with quarterly or annual reports produced by securities commissions; or anyone who is interested to integrate a digital resource or set of resources that they produced. The rule sets can be derived in relation to content boundaries that are explicit, such as proprietary mark-up of a word-processing document that defines font sizes. The rule sets also can be derived in relation to content boundaries that are implicit, such as punctuation or grammatical standards in a searchable pdf or ASCII text file.

The granularity module also generates categorical tags for each of these finite elements, where the categorical tags assigned to each of the finite elements are based upon an analysis (defined by the set of expert system rules) of the contents of each of the finite elements. The categorical tag can include a standard classification such as, for example, “Dewey Decimal-type” number. The categorical tag can also include an organizational attribute (such as pertaining to the type or location of the finite element with respect to the rest of the rest of the informational resource), a date-stamp, a categorical word, etc. The categorical tags may be inserted into the finite element, or may be linked to or associated with the finite element in another manner. With the categorical tags, the index module parses through the finite elements identified/created/processed by the granularity module and creates a searchable index having a hash table record for each of the finite elements identified and generated by the granularity module. The searchable index is a multi-level inverted index, where each record includes an address or location of the corresponding finite element (and, in turn, the categorical tag included therewith), and strings (such as words, phrases, etc.) contained in the finite element and their frequency (i.e., their weight) within the finite element in relation to multiple levels of granularity.

Once the multi-level inverted index is created, a search of the multi-level inverted index may be performed. Key strings (such as key words, phrases or symbol segments) may be supplied by an end user as a search query, and a display hierarchy or criteria may also be selected or defined by the user. The selected display criteria will instruct the search module how to manipulate the data of the search results to display the finite elements embedded within multiple levels of granularity.

The search module accesses the search query and searches through the multi-level inverted index for hash table records matching the specific search term or query. The search results may then be displayed in collapsible/expandable (relational) structures by applying information from the categorical tags and hash table for each of the finite elements satisfying the search criteria and relational display criteria. For example, a first level of the relational display may be the dates in which the finite elements were created; a second level of the display may be the creator or context of the finite elements; and subsequent levels may be the positions in which the finite elements appear in the resource or set of resources. Alternatively, for example, the user may select to display the creator or context of the finite elements at the first level of the relational display; the dates that the finite elements were produced on the second level; and subsequent levels may be the positions in which the finite elements appear in the resource or set of resources. The operation of the search module, as with the granularity and index modules, may be based upon a set of expert rules. Therefore, if the search results are not satisfactory, the expert rules in the granularity, index and/or search modules may be modified and the procedure is performed again.

The potential number of permutations resulting from a search of the multi-level index is equal to 2^{N}, where N is the number of finite elements (independent granules broken apart from the parent resource or set of resources). For example, with 2 finite elements (A and B) it is possible to generate A or B, AB or nothing depending on the search criteria, which equates to 4 potential permutations. This means that with just 10 finite elements there are 2¹⁰ permutations, which is a number so large that is beyond conventional solutions. One way to achieve the 2^{N} permutations is to let the finite elements self-combine objectively based on their hierarchal lineages of where they originated in relation the granularity levels in an information space.

Following the search module operation, the integration module is applied to zoom in and out across levels of granularity with an interface that is operated by the user. The levels of granularity are defined initially by the rule sets that operate the granularity module. Levels of granularity also can be defined by defined by extracting metadata elements, if they exist within the digital resource or resources in the resource set. The interface would be related to the computational device and could be operated by sliding, rotating or chromatic designs; touch screen designs, audio designs; or other types of designs to relate information across a continuum.

Following the search module and integration module operations, the aggregation module allows the end user to combine segments of the resulting relational displays across selected levels of granularity. The aggregation module will assemble selected finite elements with other related finite elements. The aggregation module refers to the categorical tag of the selected finite element and hash table for information related to the location of the finite element with respect to the entire informational or concept space, and will then build a portion of the informational resource from all of the finite elements belong to that portion. For example, if the selected finite element is a paragraph of a document, the aggregation module may be configured to rebuild the chapter of the document to which the paragraph belongs. As with the other modules of the exemplary embodiment, the operation of the aggregation module may be controlled by a set of expert rules that may be modified if the results are unsatisfactory. The aggregation module can be used to construct the original information resource or set of resources as well as an infinite variety of new resources depending on the user-defined criteria.

In addition, following the search module and integration module operations, the user can select to generate a database that describes the frequencies of finite elements within and between the levels of granularity resulting from a search. This analytics module operation objectively defines the frequencies of parent-child relationships at different levels of granularity based on the inherent structural boundaries and patterns that exist in an information space.

Thus, in one aspect of the present disclosure, a method for retrieving information from an informational or concept space may include the steps of: (a) dividing the informational resource into a plurality of finite elements; (b) assigning a categorical tag to each of the plurality of finite elements, where the categorical tag includes data pertaining to a content of the finite element; (c) generating a hash table record for each of the plurality of finite elements, where each searchable hash table record includes at least one string contained within the finite element, where the string can be a word, a phrase, a symbol, a group of symbols, a data segment or the like; (d) supplying a search string; (e) searching the hash table for hash table records containing the search string; (f) arranging the results of the searching step in a relational structure according, at least in part, to the data in the categorical tags assigned to the finite elements found in the searching step; (g) displaying the results of the searching step in relational structures; and (h) quantifying the frequencies of finite elements within and between the levels of granularity.

The informational or concept space may be a single digital resource, or a plurality of digital resources, and the step of identifying the finite elements may include the steps of identifying sections or sub-sections within the resource(s) or by simply identifying the resource(s) themselves. The step of dividing the informational or concept spaces into a plurality of finite elements may be performed by an expert system according to a rule set; and the step of assigning a categorical tag to each of the plurality of finite elements may also be performed by an expert system according to another rule set. If unsatisfactory results are obtained in step (g) above, one or both of the rule sets may be modified by the end user and the steps (a) through (g) may be performed again.

Each hash table record may include an address or pointer to the corresponding finite element and may also include all of the non-common strings (e.g., words or phrases) contained within the corresponding finite element along with the frequency that such strings appear.

In another aspect of the present disclosure, a method for retrieving information from an informational space includes the steps of: defining a first rule set for dividing the informational space into a plurality of finite elements; utilizing the first rule set, dividing the informational resource into a plurality of finite elements; defining a second rule set for creating a categorical tag for one of the plurality of finite elements; utilizing the second rule set to create a categorical tag for each of the plurality of finite elements; generating hash table including a hash table record for each of the finite elements; searching the hash table for relevant hash table records; associating the relevant hash table records found in the search with corresponding relevant finite elements; identifying criteria for displaying the relevant finite elements across levels of granularity; ordering the relevant finite elements in the relational displays according, at least in part, to the categorical tag for each of the finite elements; and displaying the identifying search phrases pertaining to the relevant finite elements according to the results of the ordering step.

In another aspect of the present disclosure, a non-transitory data storage device (such as a hard drive, server or USB memory device) is provided, which includes: an informational resource divided into a plurality of finite elements, where each of the finite elements includes a categorical tag and a database record assigned thereto, where the categorical tag includes data pertaining to a content of the finite element and the database record includes at least one string contained within the finite element; and also comprises software instructions programmed to retrieve and display at least a portion of the informational space. The software instructions are configured to perform the steps of: supplying a search string, searching through the database records for relevant database records containing the search string, arranging the results of the searching step in a relational structure according to the information in the categorical tags assigned to the finite elements corresponding to the relevant database records, and displaying identifying phrases for the finite elements corresponding to the relevant hash table records in the relational structure.

In another aspect according to the current disclosure, a system for retrieving information from an informational resource includes: computer processor(s); display device(s) operatively coupled with the processor(s); searchable database(s) including at least a portion of an informational resource broken into a plurality of discrete finite elements and a respective plurality of categorical tag respectively describing content for each of the plurality of discrete finite elements, where the informational resource includes at least three of levels of granularity for the information, from a shallow level of granularity to a deep level of granularity; and non-transitory memory containing software for executing by the computer processor(s). The software includes instructions for: (a) receiving a search query and a level of granularity for display; (b) searching the searchable database for relevant finite elements associated with the search query to identify a plurality of relevant discrete finite elements satisfying the search query; (c) on the display device, displaying identifying information pertaining to the relevant, discrete finite elements in a hierarchical display, where the identifying information is displayed at the received level of granularity for display; (e) displaying an interface on the display device allowing a user to change the level of granularity for display; (f) receiving from the interface a new selected level of granularity for display; and (g) on the display device, displaying identifying information pertaining to the relevant, discrete finite elements in a hierarchical display, where the identifying information is displayed at the new level of granularity for display. In a more detailed embodiment, the identifying information pertaining to the relevant, discrete finite elements includes information to other related, discrete finite elements. Alternatively, or in addition, the other related, discrete finite elements are determined based upon information contained within the categorical tag of the relevant discrete finite element.

In an another detailed embodiment, the at least three levels of granularity include sentence level, paragraph level and document level; or the at least three levels of granularity include sentence level, paragraph level, page level, at least one of section and chapter level, and resource level; or the at least three levels of granularity include components of DNA sequence data; or the at least three levels of granularity include sections of financial reports; or the at least three levels of granularity include cells of a spreadsheet; or the at least three levels of granularity include a satellite name, a sensor system and timing information; and/or the at least three levels of granularity include any parent, child and grandchild relationship between components of the informational resource.

In another detailed embodiment, the software further includes instructions for: (h) receiving a selection of at least one of the displayed relevant finite elements; and (i) constructing a new information resource from selected relevant finite element combined with other finite elements associated with the selected relevant finite element. In an even more detailed embodiment, the other finite elements associated with the selected relevant finite element are determined based upon information contained within the categorical tag of the relevant finite element. Alternatively or in addition, the other finite elements associated with the selected relevant finite element are determined based upon positional information contained within the categorical tag of the relevant finite element. Alternatively, or in addition, the other finite elements associated with the selected relevant finite element are the additional relevant finite elements; alternatively or in addition, the software further includes instructions for (j) generating numeric data about the frequency of parent-child relationships within and between different levels of granularity that is captured within the informational resource.

In another detailed embodiment, the interface is a slider-bar interface; or the interface is a touch-screen interface; or the interface is a color continuum interface; or the interface is a rotational interface; or the interface is an acoustic interface.

In another detailed embodiment, the system is a hand-held and portable computing device; and the searchable informational resource(s) and software are part of an application loaded onto the hand-held and portable computing device.

In another aspect of the current disclosure, a non-transitory computer readable medium includes instructions for causing a computer to execute process steps for searching a digital information resource, where the process steps include: (a) dividing the digital information resource into a plurality of discrete finite elements by applying a rule set, where the rule set defines a dividing level of granularity, upon which the dividing step will occur, and where the rule set further defines a plurality of shallower levels of granularity for the digital information resource; (b) associating each discrete finite element with a tag, where the tag comprises the dividing level of granularity and a contextual identification component, where the contextual identification component uniquely identifies a contextual position of the discrete finite element in the digital resource; (c) generating a searchable database, where the searchable database comprises a database record for each discrete finite element, where each database record includes at least some content of the finite element; (d) receiving input data from a user, where the input data comprises at least one search parameter and an initial level of granularity for display for the at least one search parameter; (e) searching the searchable database using search parameter(s) received in the receiving step; and (f) displaying search results in a display format reflecting the initial level of granularity for display received in the receiving step.

In a more detailed embodiment, the process steps further include: (i) receiving a subsequent input data from the user, wherein the subsequent input data comprises a subsequent level of granularity for display; and (ii) displaying the search results in a display format reflecting the subsequent level of granularity for display. Alternatively, or in addition, the displaying step (0 further includes (i) calculating a number of deeper discrete finite elements containing search results for each finite element displayed, where the deeper discrete finite elements are discrete finite elements that have a level of granularity deeper than the level of granularity for display; and (ii) displaying the number of deeper discrete finite elements containing search results for each discrete finite element in the display format. Alternatively, or in addition, the process steps further include: (i) receiving a subsequent input data from a user, where the subsequent input data comprises a selected discrete finite element and a deeper level of granularity; and (ii) adjusting the display format for the selected discrete element to display deeper search results, where the deeper search results have a level of granularity deeper than the initial level of granularity for display.

In another aspect of the current disclosure, a system for retrieving information from an informational resource includes: one or more computer processors; at least one display device operatively coupled with the one or more processors; at least one non-transitory memory containing software for executing by the one or more computer processors, the software including: (a) a break module, configured to break an informational resource into a plurality of finite elements and create a categorical tag for each finite element, the categorical tag including data pertaining to a content of the finite element and a level of granularity for the information, from a shallow level of granularity to a deep level of granularity; (b) an index module, configured to create a searchable database having a plurality of database records, each database record corresponding to at least one of the finite elements and including at least a portion of data contained in or pertaining to the finite element; (c) a search module, configured to compare a search query with each of the database records and determine which, if any, of the database records are relevant database records; and (d) an integration module, configured to display relevant database records in a hierarchical structure and calculate the number of finite elements within and between each level of granularity for graphical and statistical analysis.

In a more detailed embodiment, the integration module is configured to receive a level of granularity for display from the user and to display search results in a display format reflecting the level of granularity for display. In yet a further detailed embodiment, the integration module is further configured to enable a user to expand a selected finite element to reveal additional search results at a deeper level of granularity. Alternatively, or in addition, the integration module is further configured to enable a user to collapse branches of the hierarchical structure to a shallower level of granularity. Alternatively, or in addition, the information resource is a plurality of information resources. Alternatively or in addition, the user selects a level of granularity from a menu; or the user selects a level of granularity by using a slide-bar; or the user selects a level of granularity by using a color continuum interface; or the user selects a level of granularity by using a rotational interface; or the user selects a level of granularity by using an acoustic interface; or the user selects a level of granularity by manipulating a touch screen interface; and/or the user selects a level of granularity using a voice recognition interface.

In another alternate embodiment, the software further includes an analytics module configured to generate numerical data from the informational resource based, at least in part, upon frequency of parent-child relationships within and between components of the informational resource that can be described objectively in relation to at least one of structural boundaries and patterns.

Embodiments of the current disclosure provide interfaces to dial, slide, zoom across levels of granularity that are based on information lineage patterns reflecting relative positions of digital objects in a concept space composed of one or more resources. In such embodiments, relationships in concept spaces can be reconstructed objectively in relation to a multi-level inverted index. In such embodiments, relationship in a concept space can be reconstructed objectively in relation to lineage/positional tags that are associated with each finite element.

Embodiments of the current disclosure provide interfaces that can be extended to dragging across or pulling down levels generated with touch screens.

Embodiments of the current disclosure can provide interfaces that can be extended to sound or voice commands, such as “show shallower” or “show deeper.”

Embodiments of the current disclosure can provide interfaces that dial, slide, and/or zoom across levels of granularity to display finite elements as well as aggregations of finite elements at deeper and/or shallower levels of granularity. In such embodiments, finite elements may be retrieved in relation to a search of a multi-level inverted index. In such embodiments, finite elements may be retrieved in relation to a search of index where each finite element contains a lineage/positional tag.

Embodiments of the current disclosure can provide interfaces that dial, slide, and/or zoom across levels of granularity to display digital objects that are independent information subsets of a resource broken into a plurality of digital objects based upon rules defined by anyone familiar with the structure of a resource or plurality of resources. In such embodiments, rules can be derived from explicit patterns associated with pre-defined structures in marked resources (e.g., positioning and attributes of HTML code inserted in text document or webpage) as well as implicit patterns in unmarked resources (e.g., pixel attributes in pictures, codons of amino acids, punctuation of text, table of contents of a resource, systematics of phylogenies). In such embodiments rules can apply to structured as well as unstructured resources. In such embodiments, digital objects may be parts of a resource or a plurality of resources; or, alternatively, may be discrete and not contiguous parts of a resource or plurality of resources.

Embodiments of a the current disclosure can provide interfaces that dial, slide, and/or zoom across levels of granularity to display digital objects that are independent information subsets of a resource broken into a plurality of digital objects based on rules that are automatically defined in relationship to statistical frequencies of patterns within the structure of a resource or plurality of resources. In such embodiments, rules can be derived from explicit patterns associated with pre-defined structures in marked resources (e.g., positioning and attributes of HTML code inserted in text document or webpage) as well as implicit patterns in unmarked resources (e.g., pixel attributes in pictures, codons of amino acids, punctuation of text, table of contents of a resource, systematics of phylogenies).

Embodiments of the current disclosure can provide dial, slide, and/or zoom interfaces that can be generated directly from the breaking of a resource or plurality of resources into finite elements.

Embodiments of the current disclosure can provide dial, slide, and/or zoom displays that produce results which can be quantified statistically in terms of the frequency of digital objects within and between the resulting levels of granularity.

In the disclosed embodiments, based on user preferences, levels of granularity can be re-arranged to dial, slide, and/or zoom to generate different relational displays based on the same search query. In the disclosed embodiments, results of dial, slide, and/or zoom displays can be aggregated to reconstruct an original resource or plurality of resources. In the disclosed embodiments, results of dial, slide, and/or zoom displays can be aggregate to construct new resources. In the disclosed embodiments fully expanded results may be displayed in 1-dimension (lists), 2-dimensions (hierarchies) or even higher dimensions.

These and other aspects and embodiments will be apparent from the following disclosure, the attached drawings and the appended claims.

### BRIEF DESCRIPTION OF THE DRAWINGS

FIG. 1 is a schematic flow-diagram representation of the operation of a first embodiment of the present disclosure;

FIGS. 2A and 2B are flow-chart representations of the operation of the embodiment illustrated in FIG. 1;

FIG. 3 is a flow-chart representation of an operation of a second embodiment of the invention, resident on a data storage device such as an e-book reader;

FIG. 4 is a schematic flow-diagram representation of the operation of a third embodiment of the present disclosure;

FIGS. 5A and 5B are flow-chart representations of the operation of the embodiment illustrated in FIG. 4;

FIG. 6 is an example of a granularity zoom interface according to an exemplary embodiment;

FIG. 7 is a block diagram representation of an exemplary embodiment as a computing device, such as a traditional computing device or a hand-held device, operating an application utilizing systems and methods described herein.

FIG. 8 is an example display output of an exemplary embodiment with break module rules and generic levels of granularity for a resource set with diverse types of unstructured digital resources;

FIG. 9 is another example display output of an exemplary embodiment of FIG. 8;

FIG. 10 is another example display output of an exemplary embodiment of FIG. 8;

FIG. 11 is another example display output of an exemplary embodiment of FIG. 8;

FIG. 12 is another example display output of an exemplary embodiment of FIG. 8;

FIG. 13 is another example display output of an exemplary embodiment of FIG. 8;

FIG. 14 is another example display output of an exemplary embodiment of FIG. 8;

FIG. 15 is an example display output of an exemplary embodiment with tailored break module rules and defined levels of granularity for a resource set with one or more unstructured resources that have uniform structural boundaries or patterns; and.

FIG. 16 is an example display output of an exemplary embodiment with tailored break module rules and generic levels of granularity across a resource set with one or more structured resources.

### DETAILED DESCRIPTION

The present disclosure embodies methods and interfaces to integrate a set of one or more digital resources into a plurality of relational displays that are linked across embedded levels of granularity that can be output into statistical formats. The present disclosure involves systems and methods for searching, retrieving, displaying and analyzing information from information and concept spaces; including: an individual text resource (e.g., a book, report, email message, treaty); a set of text resources (e.g. Web pages resident on the Internet, a digital library, a digital archive, an email repository); a set of text resources in multiple languages with different symbologies (e.g., English, Chinese, Arabic, Hindi); an individual database of alpha-numeric values (e.g., a spreadsheet); a set of databases with alpha-numeric values (e.g., multiple spreadsheets, transactional data from a business); a stream of information (e.g., satellite data transmissions, social media feeds); an individual image (e.g., a photograph, a a chart, an electrophoretic assay); a set of images (e.g., photographs stored on a camera; multiple assays); a set of symbols (e.g., a DNA sequence); mixtures of different types of resource sets (e.g., photographs mixed with texts in different languages; texts in different languages mixed with transactional data). The contents, type or format of the informational resource set is not critical. Results of a search may be displayed in collapsible/expandable formats based upon user-selected display criteria or hierarchies. Such a display hierarchies will allow the end-user to effectively and quickly obtain items of interest from the search results and to identify relational schema that can be objectively represented in quantitative formats. The current disclosure provides advancements to the technologies described in U.S. Pat. No. RE42,167, the disclosure of which is incorporated herein by reference.

For the purpose of this disclosure, the term “database,” alone, is any organized and accessible storage of electronic information; and is not intended. A “searchable database,” for example, is a “database” in which the accessible storage of electronic information may be searchable by a computerized searching tool.

For the purpose of this disclosure, a “rule” or “rule set” is not required to be an expert derived rule set unless otherwise stated.

For the purpose of this disclosure, it should be understood that, while various embodiments of the current disclosure describe various software and/or processing modules, it is not required that each module be separate and distinct from other modules, and it is within the scope of the current disclosure that any of the disclosed processing modules—and associated functionalities—may be combined.

For the purpose of this disclosure, granularity is embedded levels of structural organization within an information resource (or set of information resources) in an information space or concept space. The embedded levels can be described objectively in terms of a continuum that can be accessed at different points. The continuum may apply generically to diverse resources, all of which have embedded organizational levels from larger or shallower units (such as an entire document) to smaller or deeper units (such as a sentence within a document). The continuum also may apply specifically to a single resource or set of resources set that have a consistent structural boundaries or patterns. The interface to access different levels of embedded organization is a methodology to reveal relational schema that are objectively described in terms of parent-child relationship within and between resources in an informational space or concept space.

As will be discussed herein, granularity levels may be defined by rule sets (which may be expert rule sets, but may also be non-expert rule sets or rule sets embedded into the functionality of software source code—i.e., coded in) that may be used, for example, to break up the informational resource, index the informational resource, search the index, and/or integrate the results of the search. Such rule sets may also be used to establish granularity boundaries and/or levels within an informational resource. Such granularity establishing rule sets may include, for example and without limitation: an explicit rule set of granularity, represented by the proprietary source code in a word processing resource that may recognize various levels of granularity based upon, for example, font sizes from large to small—the font size may reflect types of section boundaries applied by the author, all of which are embedded in the resource; an implicit rule set of granularity, represented by grammatical standards of punctuation in a natural language resource may recognize various levels of granularity based upon, for example, the name of the file with pages embedding paragraphs, sentences, words and letters; a rule set that recognizes levels of granularity in a genome embedded with stop codon sequences of amino acids that define the boundaries of proteins that are coded with other amino acids in a sequential order involving repetitive and non-repetitive DNA; a rule set that recognizes levels of granularity in a 10K and/or 10Q statement for the annual and quarterly reports required by the Securities and Exchange Commission for publicly traded companies based upon, for example, the report name, name of company, name of the report, consistent sections (e.g., relating to stock, subsidiaries, assets, liabilities) within the respective report and contents within the sections at the lowest embedded level. a rule set that recognizes levels of granularity within a spreadsheet based upon, for example, the name of the file embedding rows, each of which involves at least one column, embedding a cell; a rule set that, in effect, recognizes levels of granularity based upon, for example, the table of contents for any type of digital resource (from automobile manuals to zoological records), which is an explicit directory to the embedded levels of granularity; a rule set that recognizes levels of granularity in a satellite dataset based upon, for example, the name of the satellite, name of the sensor systems each of which has records with time stamps and binary code embedded within time intervals; a rule set that recognizes levels of granularity within a cookbook based upon, for example, sections with types of meals, each of which has recipes that contain a mixture of ingredients and their volumes embedded within a baking process; a rule set that recognizes levels of granularity within a US Patent and Trademark Office patent database, based upon, for example, various sections of a patent document, including pre-defined sections (e.g., patent number, inventor, filing date, background, claims, etc.), paragraph boundaries and/or sentence boundaries.

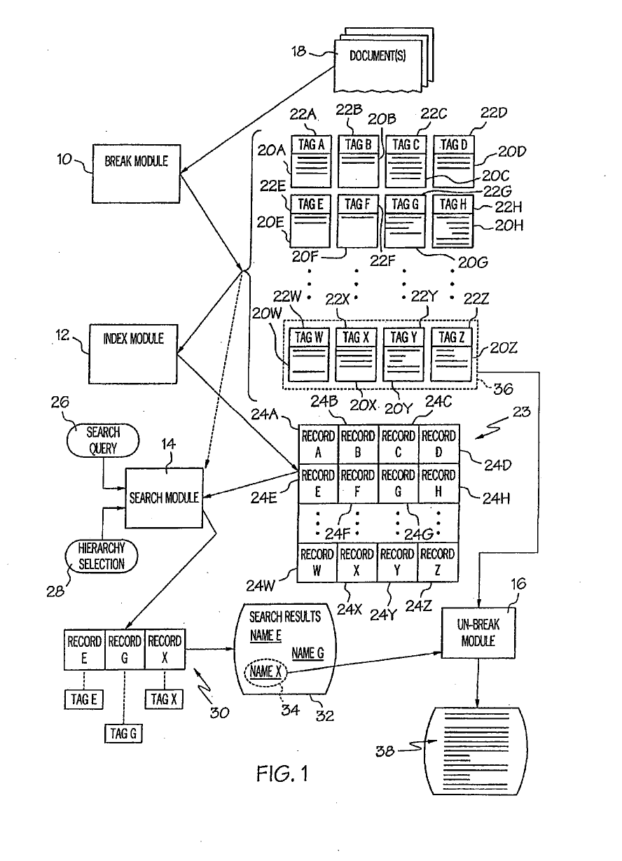

As shown in FIG. 1, in a first embodiment of the current disclosure, the information management, retrieval and display system includes four primary modules, a break (granularity) module 10, an indexing module 12, a search module 14 and an un-break (aggregation) module 16. Each of these processing modules may be an expert engines operating upon a set of expert rules that define the operation of the individual module. As will be described in further detail below, the expert rules for these modules may be generated by a person or persons having intimate knowledge of the document or documents 18 being searched; and the fine tuning of the expert rules may be an iterative process where the expert will modify or change the rules of one or more of the above modules if a search through the document or documents proves to be unsatisfactory.

The break module 10 parses through an informational resource, such as a group of documents 18 to break up the group of documents into “finite elements” 20a-20z. Each finite element is a “basket” of information from documents that is to be individually indexed and searched. The finite element is usually not a single word, phrase or symbol, but is a section or portion of an informational resource that can be identified and isolated by the break module. A simple example of a finite element would be the individual paragraphs of a document. Other examples of finite elements would include sub-chapters of a document, individual pages of a document, and other types of identifiable sections of a document. In some instances, the finite element can be the entire document itself. The break module is also responsible for analyzing the contents of each finite element 20a-20z and creating a categorical tag 22a-22z for each finite element, which is to be inserted into, or otherwise associated with the finite element. The categorical tags 22a-22z may include a standard classification based upon the content analysis such as, for example, a “Dewey Decimal” type number, or some other categorical reference number. The categorical tag may also include an organizational attribute such as pertaining to the type of finite element or the location of the finite element within the document, a date stamp, a categorical word or phrase summarizing the contents of the finite element, etc. As will be discussed in detail below, the contents of each categorical tag provides information to the search module 12 so as to assist the search module in creating the hierarchical display of the search results.

The index module parses through each of the finite elements created by the break module and creates a searchable database (hash table) 23 including a database record 24a-24z for each of the finite elements created by the break module. The searchable database 23 is a type of multi-level inverted index, where each record 24a-24z includes an address or location of the corresponding finite element and all words contained within the finite element (preferably excluding common words such as “and,” “in,” “the,” . . . ) along with their frequency of appearance within the finite element (i.e., their weight).

At some point during the process, a user, which may be an end user or may be the expert developing the rule sets, will enter a search query 26 and an optional hierarchical selection 28. The search query may be any conventional search query as available to those of ordinary skill in the art and may include search words or phrases and/or operators tying the words together. A hierarchy selection could inform the search module about the type of display format that the user wishes to see the results displayed within. Specifically, the hierarchy selection could inform the search module whether or not the search results are to be displayed in an order or structure based entirely upon the information contained within the categorical tags (research-centric), if the search results are to be displayed in an order depending entirely upon the frequency of the key words or phrases present within the finite elements (conventional), or if the search results are to be displayed in an order or structure based upon a combination of the two (document-centric).

The search module will utilize the search query to search through the database records 24a-24z so as to find the database records 30 matching the words or phrases in the search query. The search module will then, depending upon the selected hierarchy 28, display the search results 32 in an order or collapsible/expandable tree structure based upon information from the categorical tags 22 included in the finite elements 20 that are associated with the records 30 matching the search query. For example, a first level of the display hierarchy might be ordered according to the chapters of a document that the finite elements are contained within. Information regarding the chapters that the finite elements are contained within will be resident within the categorical tags associated with the finite elements. A second level of the display results may order the finite elements for each chapter based upon the weight or frequency that the search words or phrases appear within each finite element. Therefore, on the search results screen the end user will select which chapter he or she would like to view a relevant finite element from and the display will then expand to show the finite elements from that chapter matching the search query. These finite elements contained within this chapter will be ordered depending upon the weight of the search query or words. From there, the user will make a selection 34 indicating to the un-break module 16 which of the finite elements the user wishes to view.

It will be appreciated by those of ordinary skill in the art that the different combinations of ordering schemes and levels of granularity for any given hierarchy is virtually limitless. Other examples of ordering schemes and relational schema can be based upon the topic of the finite element, the author or provider of the finite element, the time/date of the finite element, the position of the finite element with respect to the information resource, etc. It is also within the scope of the invention that the hierarchy only includes one level of ordering.

While in the exemplary embodiment, the search module displays the search results in an collapsible/expandable tree structure (relational schema), it is also within the scope of the current disclosure that the display results be displayed in alternate hierarchal or relational structures. An example of an alternate hierarchal/relational structure is the use of a cascaded or tiled display to present the various levels of the hierarchy. Of course, if there is only one level of ordering, the display structure would not need to be collapsible/expandable.

The search module may also be configured to recognize that a string in the search query may have other permutations, which may be used by the search engine to provide matches with the database records. For example, if the search query includes a word in a first language, it is within the scope of the invention for the search module to provide the word in other languages when looking for matches with the database records. Likewise, it is within the scope of the invention for the search module to provide other known forms or tenses of the word; and it is also within the scope of the invention for the search module to provide other search words having a similar or the same meaning.

The un-break module 16 accesses the categorical tag of the selected finite element 34 to determine the other finite elements 36 of the documents 18 that are to be grouped together so as to form a single contiguous display 38. For example, if the selected finite element 34 is a paragraph of the document, the un-break module 16 will refer to the categorical tags of the remaining finite elements to determine the other finite elements 36 that appear on the same page as the selected finite element so as to display the entire page 38 rather than the single paragraph. Likewise, the un-break module can group related finite elements together in a contiguous chapter, section, or other contiguous identifiable portion of the document or documents. Simply put, the un-break module is used for displaying the selected finite element in context with the remaining portions of the informational resource or concept space.

While, in the current embodiment, the un-break module is utilized to reconstruct contiguous portions of the informational resource, it is within the scope of the disclosure to configure the expert rule sets of the un-break module to construct new informational resources using the selected finite elements and other finite elements from the original informational resource. For example, the un-break module may be configured to compile all of the finite elements matching the search query into a new informational resource, using the categorical tags for these finite elements to dictate the order in which the finite elements will be compiled. In another example, the un-break module may be configured to review the categorical tag of the selected finite element to determine other finite elements that are related to the selected finite element based on the date that the finite elements were created, or the author/owner of the finite element, or the content of the finite element; and the un-break module will then construct a new informational resource compiling all of the related finite elements.

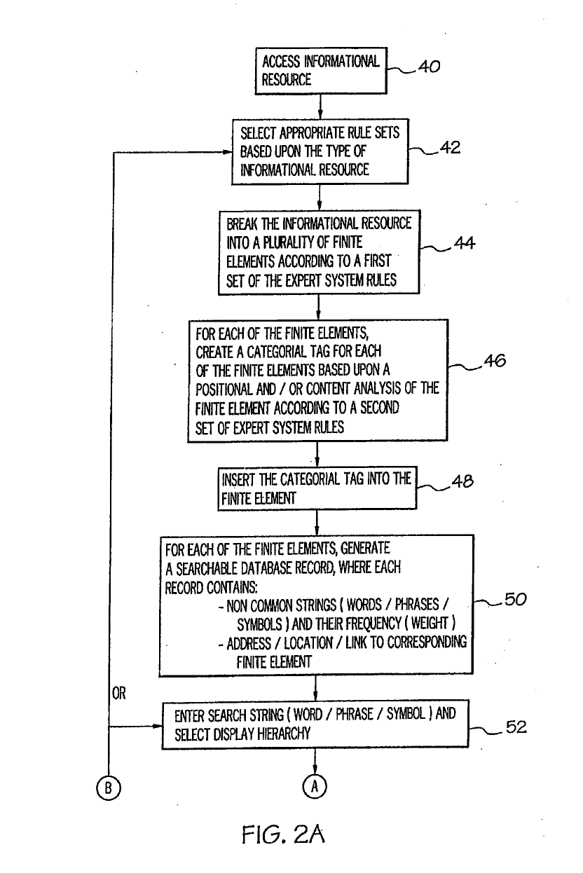

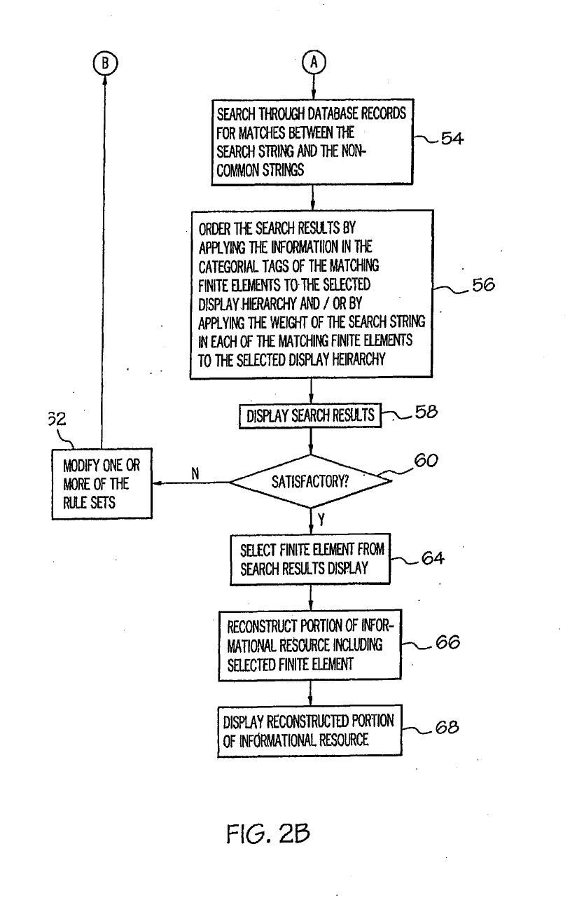

FIGS. 2A and 2B provide a flow chart representation of an operation of the information management, retrieval and display system for the embodiment described above. As shown in functional block 40, a first step is to access the informational resource being examined. As illustrated in functional block 42, the next step is to select the appropriate expert rule sets to apply for searching through the informational resource. The particular rule set selected will depend upon the type of information resource that was accessed in step 40. For example, a set of expert rule sets used for searching through and analyzing the Antarctic Treaty will be different than a set of rule sets used for analyzing and searching through volume 37 of the Code of Federal Regulations. As shown in functional block 44, the next step is to break the information resource into a plurality of finite elements according to a first set of the expert systems rules. As discussed above, this step involves breaking the informational resource into identifiable segments of information such as paragraphs, subsections, pages, chapters, subchapters and the like. An example rule set for breaking the Antarctic Treaty into a plurality of finite elements is provided below in Table 1.

TABLE 1
FINISHED EXAMPLE OF A ‘RULE SET’ FOR AUTOMATICALLY
DIVIDING DOCUMENTS INTO SEGMENTS OR ELEMENTS'

| DOCUMENT | SPECIFIC | PATTERN |
|---|---|---|
| DIVISION | DOCUMENT | MATCHING |
| LEVELS | DIVISIONS | RULES |
| Primary Level | Antarctic Treaty, | Recognize by bolded large fonts |
| | Conventions. Protocol | centered on page |
| | And its Annexes | |
| Secondary Level | Recommendations, | Recognize by Roman numerals |
| | Measures, etc. | |
| Tertiary Level | Articles within | Recognize by medium fonts |
| | documents from the | centered on page with a colon |
| | primary or secondary | |
| | levels | |
| Grouped Level | Antarctic Treaty | Group documents by their |
| | Consultative Meeting | Roman numerals |
| Appended Level | Year | Append the signature date for |
| | | documents at the primary, |
| | | secondary or grouped levels |

1 Based on the public-domain documents in the Antarctic Treaty Handbook which has been published since the 1960's by the United States Department of State in hardcopy form only and which now has been converted into a searchable database.
2 Source codes are described using JAVA but could easily be written in PERL or any other programming language. See Appendix A for example source code segments

As shown in the above table, the example rule set is adapted to divide the Antarctic Treaty into a plurality of levels where a primary level of the Treaty, which involves the Antarctic Treaty, Conventions, Protocol and its Annexes, is recognized by the search engine by identifying bold, large font centered on a page. A secondary level, illustrated by Recommendations and Measures contained within the Treaty, is recognized by the search engine by identifying Roman numerals. A tertiary level is utilized to divide up the primary and secondary levels into smaller finite elements. This tertiary level of finite elements is recognized by the search engine by identifying medium fonts centered on a page with a colon. The remaining levels of the table should be apparent to those of ordinary skill in the art upon analyzing the table and the associated pattern matching rules.

Accordingly, the purpose of the above rule set is to create an automatic tool for matching patterns that distinguish hierarchies, segments or elements within any type of informational resource. The rule set is developed in relation to user-defined requirements for the segments or elements that need to be indexed and searched within the informational resource. It will also be apparent to those of ordinary skill in the art that the rule sets may be greatly simplified in informational resources that include already distinguished segments or elements, such as in separate columns or blocks. The rule sets may be designed by an expert having intimate knowledge of the informational resource, in an iterative manner utilizing feed-back loops as will be described below.

As shown in functional block 46, a next step is to create a categorical tag for each of the finite elements based upon a positional and/or content analysis of the finite element according to a second set of expert system rules. An example of a rule set for defining categorical tags for finite elements extracted from the Antarctic Treaty is provided below in Table 2.

TABLE 2
EXAI\1PLE OF CATEGORICAL TAGS THAT WERE
AUTOMATICALLY ATTACHED TO FINITE ELEMENTS
CREATED WITH THE USER-DEFINED ‘RULE SETS’ (SEE TABLE 1)'

| DOCUMENT | |
|---|---|
| DIVISION | |
| LEVELS | SPECIFIC DOCUMENT DIVISIONS |
| Primary Level | Antarctic Treaty. Conventions. Protocol and its Annexes |
| Secondary Level | Recommendations. Measures, etc. |
| Tertiary Level | Articles within documents from the primary or |
| | secondary levels |
| Grouped Level | Antarctic Treaty Consultative Meeting |
| Appended Level | Year |

1 Based on the public-domain documents in the Antarctic Treaty Handbook which has been published since the 1960's by the United States Department of State in +hardcopy form only and which now has been converted into a searchable database.
2 Source codes are described using JAVA but could easily be written in PERL or any other programming language. See Appendix A for example source code segments.

As shown in Table 2, the categorical tag may include notation indicating the finite element's position within each of the various identified levels of the Antarctic Treaty. For example, the categorical tag may include information indicating if on a primary level, the finite element is contained within the Antarctic Treaty, the Conventions, the Protocol or its Annexes. On a secondary level, the categorical tag will indicate whether or not the finite element is included in the Recommendations, Measures, etc. As shown in the bottom of the table, the categorical tag for each of the finite elements will also include a content base notation indicating the year that the particular section or finite element was created. Of course, the type and variations of positional and/or content base notations included in the categorical tags are virtually limitless. For example, the rule set may be configured to analyze the contents of the finite element so as to provide a categorical word or phrase which provides a clue to the user as to the contents of the finite element. Similarly, rather than utilizing a word or phrase, the rule set can analyze the contents or position of the finite element to provide a categorical reference number to the finite element, such as a Dewey Decimal type number.

As shown in functional step 48, a next step is to insert the categorical tag created above in step 46 into the finite element created in step 44. As shown in functional block 50, a next step is to generate, for each of the finite elements, a searchable database record. Each database record preferably contains the noncommon strings (e.g., words, phrases, symbols) contained within the finite element along with their frequency (i.e., weight). Furthermore, each database record will include an address, location or link to the corresponding finite element. As shown in functional block 52, a next step is to enter a search string such as a word, phrase or symbol(s) and to select a display hierarchy. As shown in functional block 54, a next step is to search through the database records created in functional block 50 for matches between the search string and the noncommon strings of the database records. This searching step will identify the relevant database records having noncommon strings matching the search string. As shown in functional block 56, the relevant database records found in the searching step 54 will be ordered by applying information from each of the categorical tags of the relevant database record's associated finite element to the selected display hierarchy and/or by applying the weight of the matching search strings in the relevant database records to the selected display hierarchy.

For example, a first level of the display hierarchy for the Antarctic Treaty might be the year that the finite element was created; the second level might be ordered according to the order of the Articles of the Antarctic Treaty; and a third level of the display hierarchy might be ordered according to the weight of the matching strings contained within the database records.

As shown in functional block 58, a next step would be to display the search results in the collapsible/expandable hierarchy on a display screen. As shown in functional block 60, the user will determine whether the search results were satisfactory, and if not the process will advance to functional block 62 where the user will modify one or more of the rule sets and will return either to functional block 44 or to functional block 52 depending upon which rule sets have been modified.

If, in functional block 60, the search results are satisfactory, the process will advance to functional block 64 where the user will select one of the finite elements from the search results display. Then in functional block 66, the categorical tag of the selected finite element will be used to identify other finite elements that are to be grouped together with the selected finite element to create a contiguous portion of the informational research to be displayed. Finally, in functional block 68, the contiguous portion of the informational resource will be displayed on the display screen or printed.

It is envisioned that an expert having intimate knowledge of the informational resource may develop the rule sets based upon his or her knowledge of the informational resource. Thereafter, once the rule sets have been fully developed, the feed-back portion of the above-described flow chart will no longer be necessary.

Furthermore, once the rule sets have been fully developed, the search module, the unbreak module and the fully developed rule sets may be incorporated onto a data storage device (such as a CD ROM, a disk-drive, USB memory device, smart phone or e-book reader and the like) along with an informational resource pre-broken into its plurality of finite elements, where each of the finite elements includes the corresponding categorical tag previously created therefore, along with the pre-created searchable database for the plurality of finite elements. Therefore, such a storage device would essentially provide a searchable document that includes the entire content of the informational resource along with a search engine that has been fined tuned by an expert with intimate knowledge of the informational resource, so that end users of the e-book reader (or other type of storage device) would be able to take advantage of the expert's knowledge and experience in searching through the informational resource contained therewith.

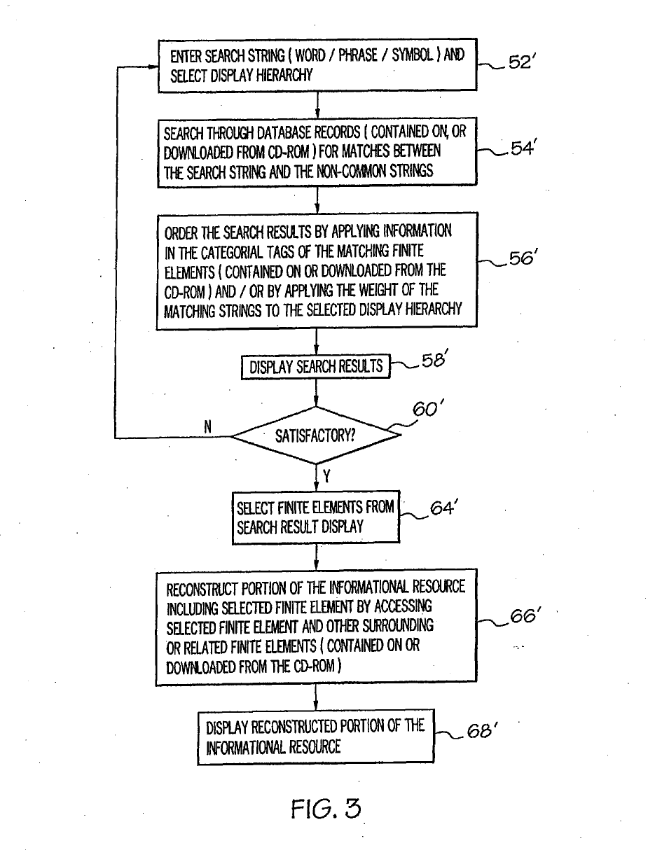

As shown on FIG. 3, a flow chart representation of an embodiment of the invention resident on a data storage device, such as an e-book reader, is presented. Essentially, this embodiment is equivalent to the embodiment described in FIGS. 2A and 2B above, except that the development of the rule sets are not longer required. As shown in functional block 52′, a first step would be for the end user to enter a search string and select a display hierarchy. In functional block 54′, the next step would be for the search module to search through the database records contained on or downloaded from the e-book reader to match the search string with the non-common strings contained in the searchable database records. As shown in functional block 56′ the next step would be for the search module to order the search results by applying information in the categorical tags of the matching finite elements (which are contained in, or are downloaded from the e-book reader) and/or by applying the weight of the matching strings to the selected display hierarchy as discussed above. As shown in functional block 58′ the next step is to display the search results in preferably a collapsible/expandable hierarchy. As shown in functional block 60′, the end user, upon viewing the search results will determine whether or not the results are satisfactory. If not satisfactory, the process will return to functional block 52′ where the end user will input a new search string and/or will select a new display hierarchy. If the display results of step 58′ are satisfactory, the process will advance to functional block 64′ where the end user will select one of the finite elements from the search results display. Advancing to functional block 66′ the un-break module will reconstruct the portion of the information resource that includes the selected finite element by accessing the selected finite element and the other surrounding or related finite elements from the e-book reader to create the contiguous portion of the informational resource that included the finite element.

In another embodiment of the present disclosure the information management, retrieval and display system may be specifically configured to search through a number of individual Web pages resident on the Internet and to display the results of the search in a collapsible/expandable format based upon a user selected display criteria or hierarchy. In such an embodiment, a break module in the form described above may not be necessary because each Web page may already be considered a “finite element” and the search engines will not be able to modify the Web pages.

With such an embodiment, the search engine may not be able to insert the categorical into the finite elements. Therefore, in this embodiment. the categorical tags may be either stored separately from the finite elements or incorporated directly into the database records. Furthermore, it is envisioned that the Web page creators may desire to create their own categorical tags for their Web pages rather than having the search engine create one for them. With this feature, the Web page designer may be able to influence the search results, perhaps to achieve a more accurate description of his or her Web site. Of course, in such a feature may also be used by the Web designers in a deceptive manner, where the categorical tag will cause the Web page to be listed in search results when the searcher is looking for an entirely different type of information. Recognizing this potential problem, the index module may include an option where it will compare the actual contents of the Web page against the embedded categorical tags inserted by the Web page designer, and may create a new categorical tag to be inserted in the database record for the Web page if there is a significant difference between the two. Likewise, the search engine can be configured to include an optional filter that will filter out Web sites having unsavory contents as indicated by the embedded categorical tags or as determined upon a review of the content of the Web page itself.

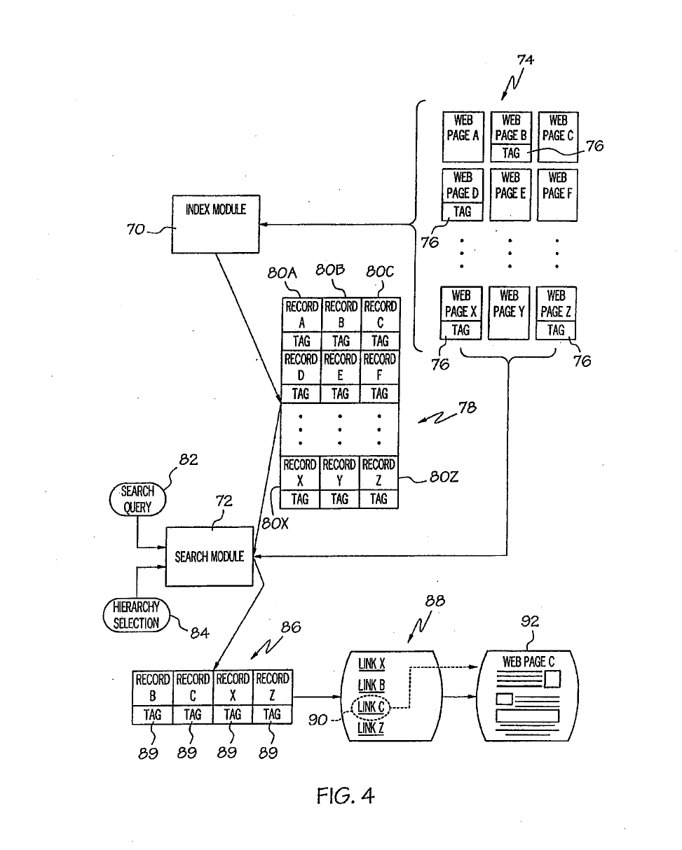

As shown in FIG. 4, in such an embodiment of the invention, the information management, retrieval and display system includes two modules, an index module 70 and a search module 72. Each of these processing modules may be expert engines operating upon a set of expert rules that define the operation of the individual module. The index module 70 will periodically crawl through the volume of Web pages 74 utilizing a conventional Web crawling or Web searching technology such as a spider technology, which is adapted to examine each Web page (or as many as possible) provided on the Internet. As shown in FIG. 4, several of the Web pages may include a predefined, embedded categorical tag 76 included therewith. As discussed above, such an embedded tag 76 would be inserted in the Web page by the Web page designer so that the search engine of FIG. 4 would utilize this predefined embedded categorical tag rather than creating one on its own. An example of a rule from the expert rule set for defining the categorical tag in this embodiment would be to identify the most prominent word or phrase on the initial screen appearing when the Web site is accessed.

The index module 70 will also create a searchable database 78 including a database record 80a-80z for each of the Web pages accessed above. This searchable database 78 is a type of reverse index for each record 80a-80z includes a link to a corresponding Web page, all words contained within the Web page (preferably excluding common words) along with their frequency of appearance within the Web page, and a categorical tag created by the index module or a copy of the categorical tag that was included in the particular Web page as described above. It is envisioned that the index module would constantly be re-accessing the Web pages 74 and updating the searchable database 78, since the contents of Web pages are also constantly being updated or changed.

When a user wishes to conduct a search using the search engine, the user will enter a search query 82 and select an optional hierarchical selection 84. The search query may be any conventional search query as available to those or ordinary skill in the art, it may include a search word or phrases and/or operators tying the words together. The hierarchy selection would inform the search module the type of display format that the user wishes to see the results displayed within. Specifically, the hierarchy selection would inform the search module whether or not the search results are to be displayed in an order or structure based entirely upon the information contained within the categorical tags (research-centric), if the search results are to be displayed in an order depending entirely on the frequency of the key words or phrases present within the finite elements (conventional), or if the search results are to be displayed in an order or structure based upon a combination of the two (document-centric).

The search module 72 utilizing a search query 82 to search through the database records 80a-80z so as to find the database records 86 matching the words or phrases in the search query. The search module will then, depending upon the selected hierarchy 84, display the search results 88 in an order or in a collapsible/expandable tree structure based upon information from the categorical tags 89 included within the database records 87 matching the search query. From the display 88, the user will make a selection 90 of a link to a Web page that he or she wishes to view and the search module will then display the Web page 92 on the display screen.

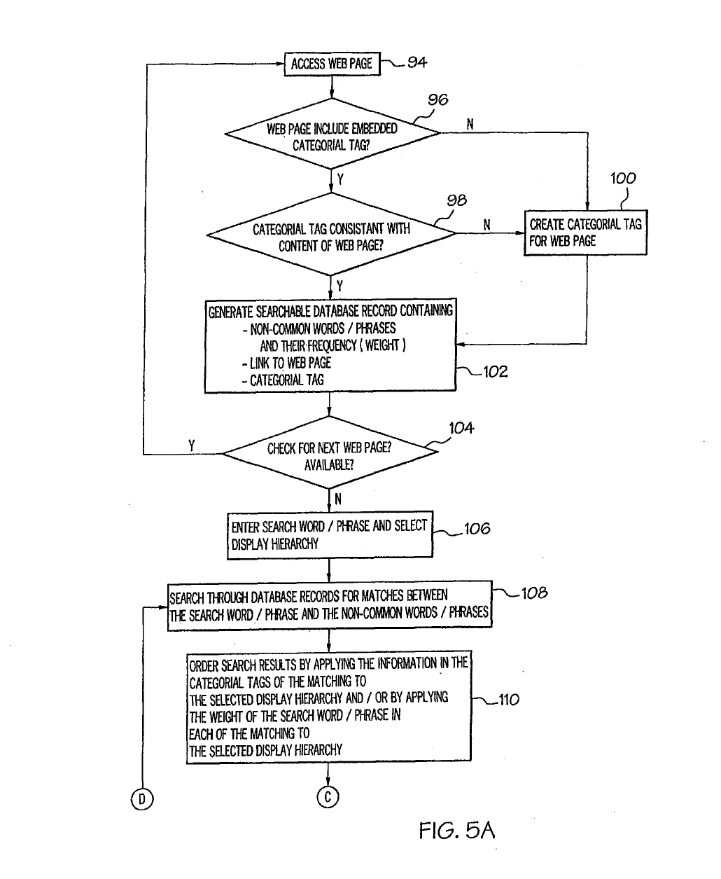

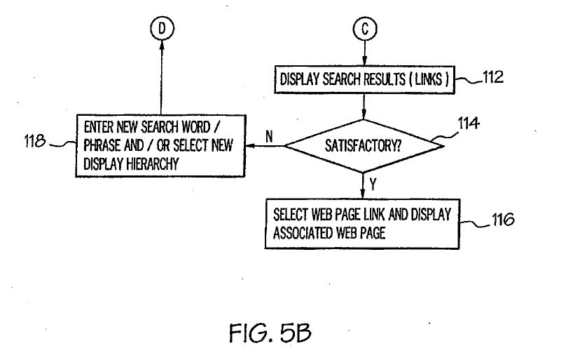

FIGS. 5A and 5B provides a flow chart representation of an operation of the embodiment described above in FIG. 4. As illustrated in the function block 94, a first step is to access a Web page on the Internet. In functional block 96, the next step is to determine whether the access Web pages includes an embedded categorical tag. If the Web page includes an embedded categorical tag the process would advance to functional block 98 where the process will determine whether the embedded categorical tag is consistent with the content of the Web page. If the Web page does not include an embedded categorical tag or if the categorical tag is not consistent with the content of the Web page, the process will advance to functional block 100 where a categorical tag will be created for the Web page. If the embedded categorical tag is consistent with the content of the Web page in step 98 or if the categorical tag is created for the Web page in step 100, the process will advance to functional block 102 where a searchable database record will be generated for the Web page. This searchable database record will include the non-common words or phrases contained within the Web page and their frequency (i.e., weight) a link to the Web page and the categorical tag embedded within the Web page or created in step 100 above. The process will then advance to functional block 104 to determine whether a next Web page is to be accessed. If so, the process will return to functional block 94. If the searchable database is complete, the process will advance to functional block 106 where a user will enter a search word or phase in selected display hierarchy.

Advancing the functional block 108, the search engine will search through database records for matches between the search word or phrase and the non-common word or phrases contained within the database records. Advancing to functional block 110 the search engine will then order the results of the search by applying the information in the categorical tags matching database records to the selected display hierarchy and/or by applying the weight of the search word or phrase in each of the matching database records to the selected display hierarchy. Advancing to functional block 112, the next step would involve displaying the search results on the display screen. In functional block 114, if the search results are satisfactory, the user will select a Web page link on the display screen and the search engine will display the associated Web page selected. If the search results are unsatisfactory, the process will advance to functional block 118 where the user will enter a new search word or phrase and/or select a new display hierarchy and the process will return to functional block 108 so that another search can be performed.

In the present embodiment, the expert rule sets for creating the categorical tags, and the database records may be defined by an expert utilizing an iterative variation of the above process on a limited portion of the Internet (similar to that as described in FIGS. 2A and 2B above). Once the rule sets have been refined, the rule sets can be applied to the entire Internet. The above described search engine can be operating on a Web site, or may be contained in a memory device such as a CD ROM which can be downloaded onto a computer having access to the Internet, or may be contained on a portable computing device, such as a smart-phone or e-reader.

With respect to the hierarchical and/or expandable/collapsible displays provided by certain embodiments as discussed above, an interface or tool may be provided that allows a user to select the granularity level of display. Similar to the ability for a viewer to zoom in and out of an image, the interface or tool may provide the ability to increase or decrease the level of granularity (zoom in our out) of the displayed results. Such an interface or tool will be referred to herein as a “contextual zoom” interface.

As discussed herein, the structure or structures of a digital resource or plurality of digital resources can be objectively defined in terms of the inherent boundaries, hereby called the inherent structure, which can be applied with certainty across the entire resource set. For digital resources based upon text, the inherent structure can depend on content strings that are applied in a conventional manner (such as a sentence bounded by a period or a word bounded by a space in western languages) and be independent of the medium of presentation (such as software for word processing). The inherent structure can depend on the medium of presentation (such as a page break or line in a ‘pdf’ file) and be independent of the content strings. The inherent structure can depend on the medium of presentation and be dependent on the content strings (such as a mixture of symbologies). The inherent structure also can depend on the context of the information.

The structure or structures of a digital resource or plurality of digital resources can also be subjectively defined in terms of the probable boundaries, hereby called the probable structure, that are applied with some level of uncertainty. The probable structure can depend on statistical analyses of content strings (such as word pairs, pixel densities or energy amplitudes), but be independent of the medium of presentation (such as different palettes or receivers). The probable structure can depend on statistical analyses of content strings and be dependent on the medium of presentation. The probable structure also can be independent of content strings with arbitrary boundary assignments based on content or context thresholds.

As discussed herein, structural boundaries may be defined by a rule set or rule sets that enable an individual digital resource or plurality of digital resources to be divided or aggregated into finite elements up to the level of the resource set. Upon the operation of the rule set or rule sets, the inherent or probable level or levels of granularity are associated dynamically with each finite element, hereby called the granule genealogy.

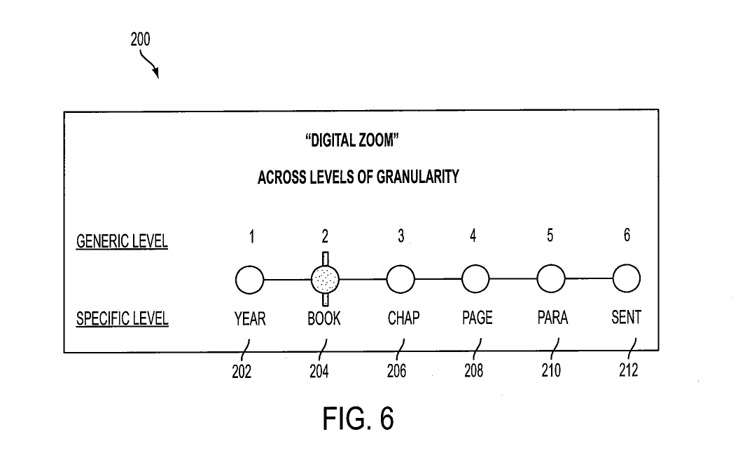

FIG. 6, provides an example of a granularity zoom interface 200. The interface 200 allows a user to select a level of granularity for search and/or display based on the structural boundaries that have been defined. The user selection defines the selected search and/or display level of granularity (such as a page rather than a sentence) that will be operated across the relevant resource set. The user then conducts a search of the resource set using the content symbols that have been indexed to generate an expandable-collapsible hierarchy display that reveals the granule genealogies of all finite elements that contain the search string from the resource set down to the selected level of granularity. Results also will be displayed as a set of data that define the number of finite elements within and between each level of the hierarchy for additional graphical or statistical analyses. As shown in FIG. 6, the interface 200 allows a user to select multiple levels of granularity for the search and/or search results; from a shallow level of granularity (e.g., year or book level) to a deep level granularity (e.g., string or sentence level). In the illustrated example, the levels of granularity go from Year 202, to Book 204, to Chapter 206, to Page 208, to Paragraph 210 to Sentence 212 (shallow to deep granularity) on a specific characterization of granularity and go from level 1 to level 6 (shallow to deep granularity) on a generic level. As shown in FIG. 6, in this example, the Book level 204 of granularity (level 2) has been selected by a user.

The search algorithm may also be applied at the level of granularity that has been selected with the granularity zoom interface. For example, using a Boolean search for “red+truck”, may reveal pages where these two terms co-occur. However, “red+truck” may not occur in any sentences. Consequently, there would be results at the page level but not the sentence level.

Post-search, the granularity zoom interface 200 may allow the user to further expand or retract the granularity within any individual finite element, or any combination of finite elements, anywhere in the hierarchy down to the deepest possible level of granularity that has been defined by the rule set or rule sets. Post-search, the granularity zoom interface 200 may also allow the user to collapse the granularity within any individual finite element anywhere in the hierarchy up to the shallowest level of the resource set. After the user has completed the pre-search and post-search selection with the granularity zoom interface, the resulting finite elements can be aggregated in part or in whole to generate a new resource set as previously discussed herein.

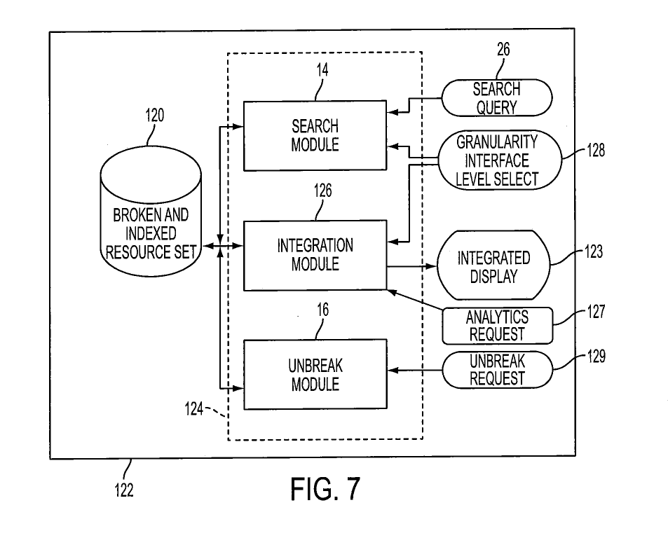

Referring back to the embodiment of FIG. 3, the embodiment may also include a functional block of selecting by a user (using a form of a granularity interface) a level of granularity for display of one or more of the matching finite elements listed in the collapsible/expandable hierarchy; and adjusting in the display the granularity of the selected one or more matching finite elements based upon the selected level of granularity. In such an embodiment, as shown in FIG. 7, the data storage device 120 may be resident on a computerized tool 122, such as a smart phone or computing note-pad device, having an integrated display 123 (which may be a touch-sensitive display, for example, or a standard display where the device has other user input peripherals such as a touch pad, keyboard and/or mouse) and the functional blocks may be implemented by an application (such as, for example, an encyclopedia algorithm in which a user may search and display into a multi-volume encyclopedia stored on the computerized tool), operating on the computerized tool's processing circuitry 124. In such an embodiment, the application may only utilize, for example, the search module 14 and unbreak module 16, but may also include an integration module 126 controlling the various displays and also controlling some or all of the user inputs, such as selection by the user of a level of granularity for display using the granularity zoom interface 128. The analytics request 127 may inform the integration module 126 to capture the data about the frequencies of parent-child relationships within each level of granularity for a given search query 26. These data can be exported to a spreadsheet for subsequent statistical and graphical analyses. Further, in the current embodiment, the data storage device 120 may include the informational resource that has already been broken into finite elements, and may also include the searchable reverse index and hash table. With such an embodiment, the granularity zoom interface 128 may be implemented in many forms; including, without limitation, a menu, a slide-bar, a touch-screen interface (using pinch-in for zoom in—and pinch-out for zoom out, for example), a voice recognition interface (recognizing voice commands such as “sentence level display” or “page level display” for example). The unbreak request 129 will activate the unbreak module to generate a contiguous portion of the information space based on the finite elements that are retrieved with a search query 16 and integrated at a selected level of granularity 128.

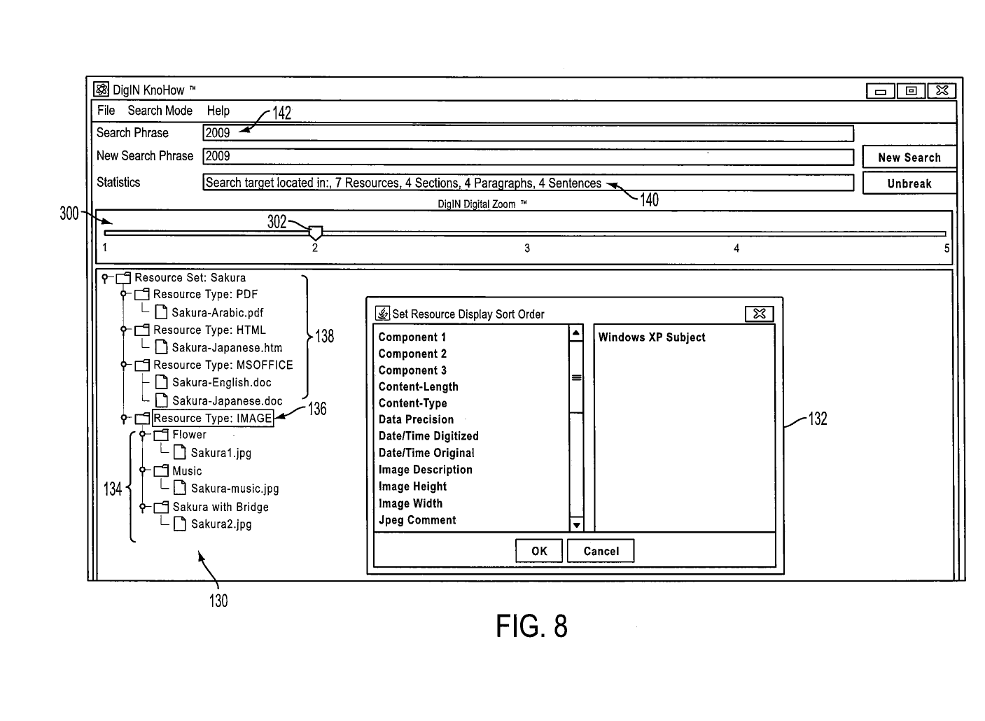

FIG. 8 provides an example hierarchical display output 130 utilizing a granularity zoom interface (referred to in the figure as the DigIN Digital Zoom™) based on a generic rule set for the break module 10 for diverse digital resource types. Metadata, shown in window 132, is an example of explicit granularity information contained within a digital file that can be used to define various levels in the display hierarchy. The display output screen includes a granularity zoom interface 300 in the form of a slider bar, in which a user manipulates a slider 302 along the bar to select a desired level of granularity for display from the most shallow “1” to the deepest “5.” In the example shown in FIG. 8, the subject level 134 of metadata from several image files (e.g., “flower”, “music,” “sakura with bridge”) was selected and added to deeper level of granularity for the “IMAGE” resource type 136 by moving the slider 302 on the granularity zoom bar 300 to the resource type—“2” level of granularity. The finite elements satisfying the search query “2009” 142 at this selected level of granularity were revealed, including three .jpg images (Sakura1.jpg, Sakura-music.jpg and Sakura2.jpg). Also shown in the hierarchical display are search results at shallower levels of granularity 138, including a .pdf file in Arabic, .doc files in both English and Japanese, and an .HTM file in Japanese. Additionally, statistical output 140 of the frequencies of hierarchy levels within the set (e.g., Sakura) of resources that contain the finite elements are shown (e.g., 7 resources, 4 sections, 4 paragraphs and 4 sentences).

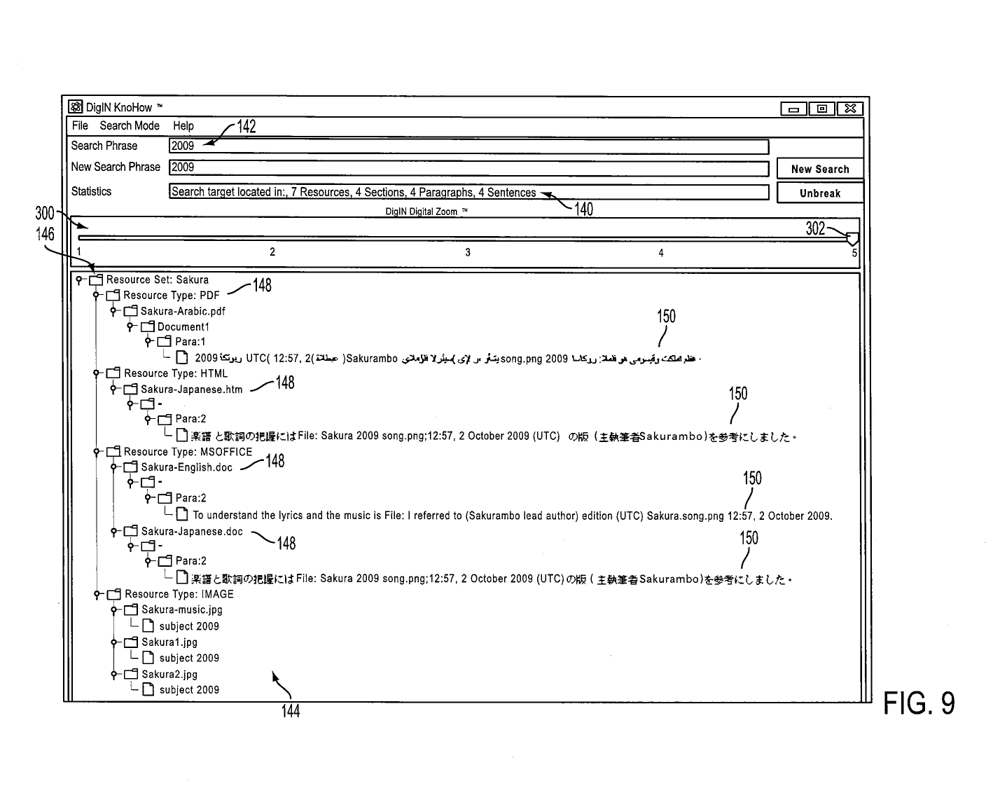

FIG. 9 is an illustration 144 of the same search results shown in FIG. 8, except that the granularity zoom slider 302 was set to the deepest level of granularity (sentence level—“5”) across the entire resource set, “Sakura” 146. Consequently, for the text documents 148, the sentences 150 in which the search term “2009” 142 appears are displayed in the display hierarchy.

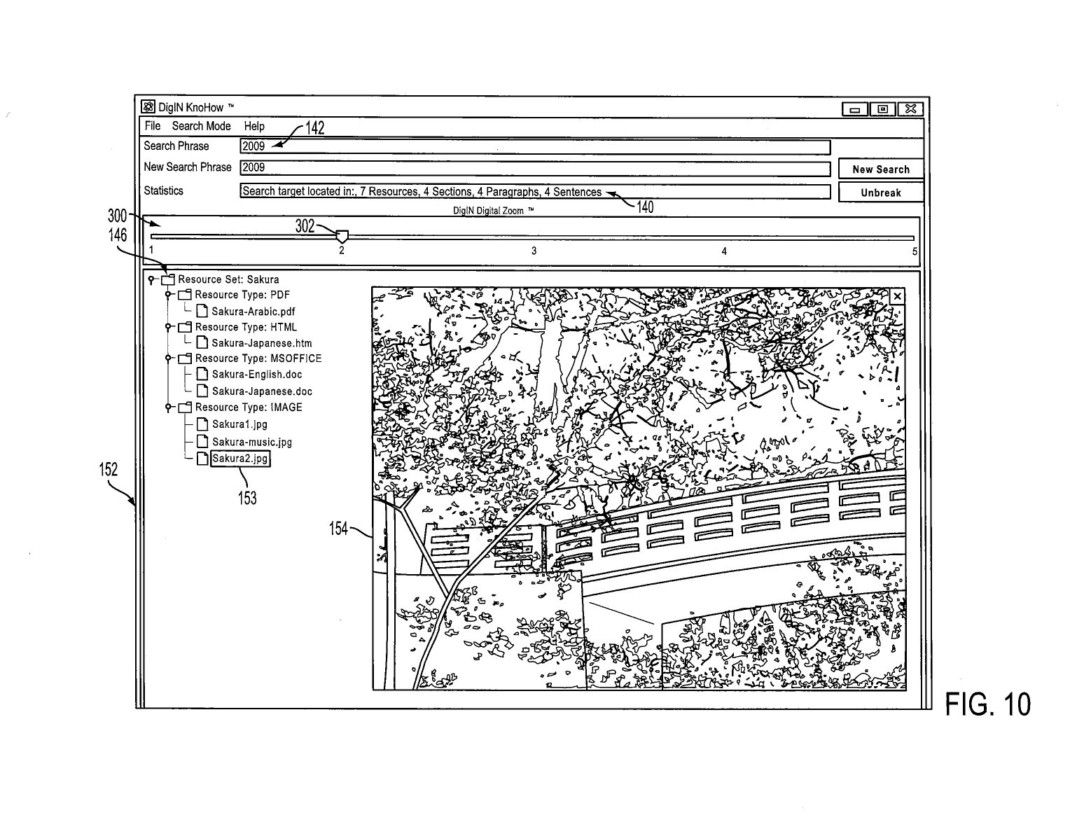

FIG. 10 is an illustration 152 for the same search results shown in FIGS. 8 and 9, where the granularity zoom slider 302 is set to a shallower level of granularity (resource type—“2”) across the entire resource set, “Sakura” 146. Again, those files including the search results for “2009” 142 are revealed. Then, in this example, the revealed file “Sakura2.jpg” 153 is selected for display on the right 154.

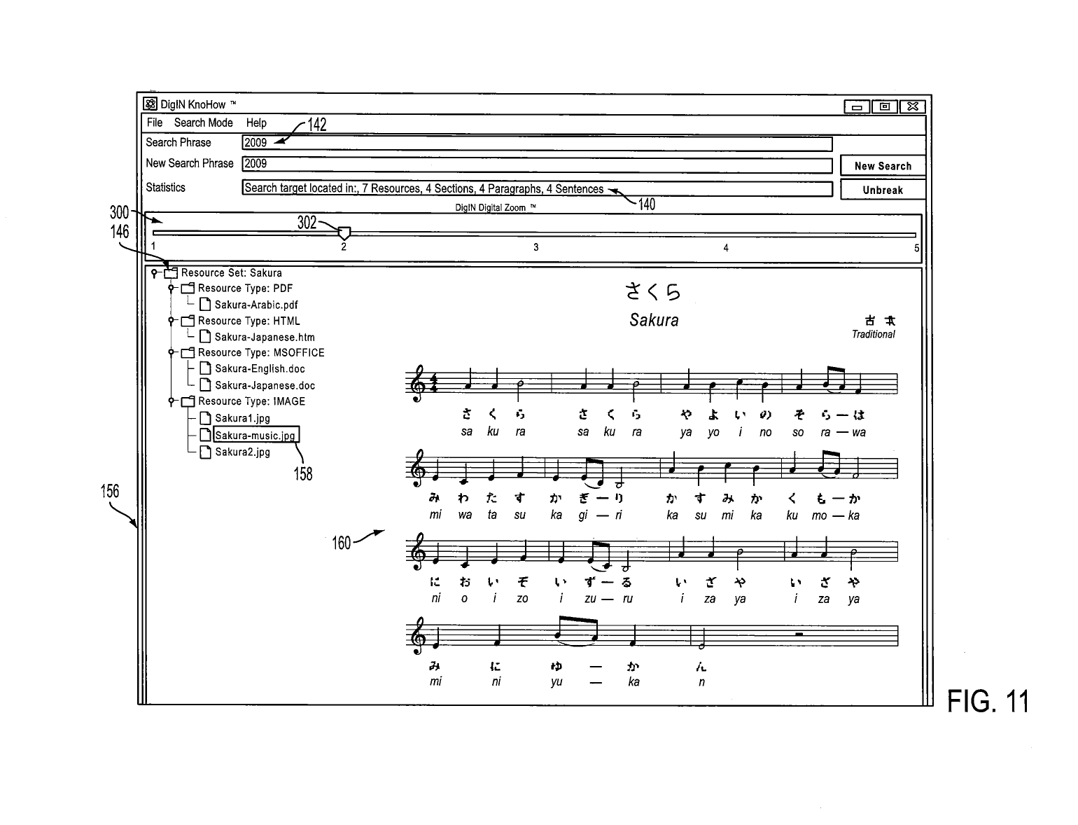

FIG. 11 is an illustration 156 for the same search results shown in FIGS. 8, 9 and 10, where the granularity zoom slider 302 is set to a shallower level of granularity (resource type—“2”) across the entire resource set, “Sakura” 146. Again, those files including the search results for “2009” 142 are revealed. Then, in this example, the revealed file “Sakura-music.jpg” 158 is selected for display on the right 160.

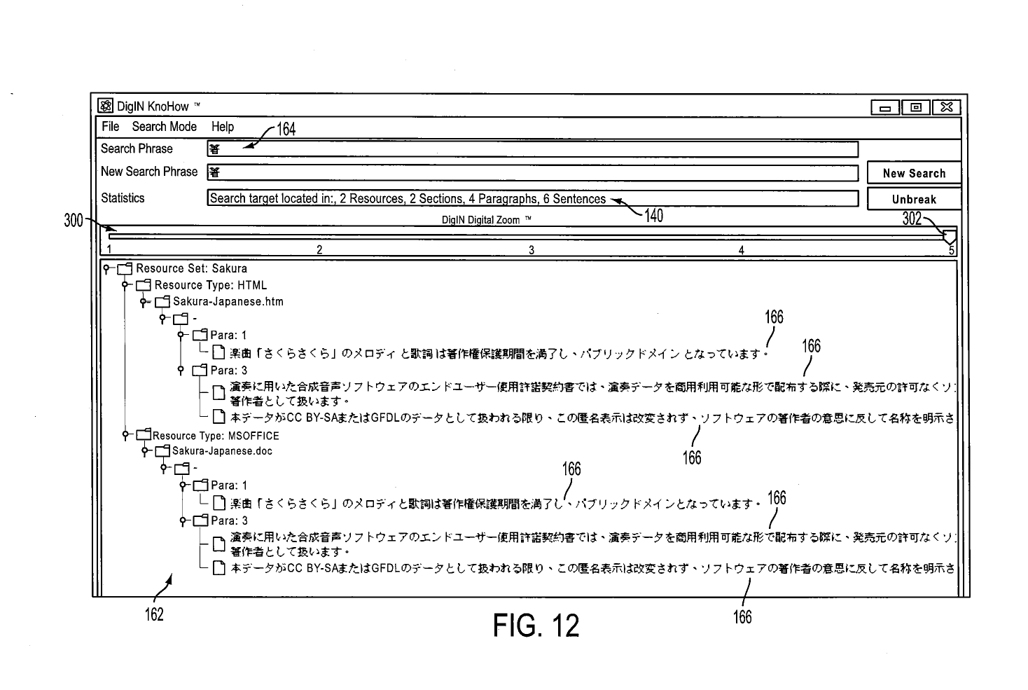

FIG. 12 is an illustration 162 of a search results for a Japanese character 164 within the resource set of FIG. 8, where the granularity zoom slider 302 on the slider bar 300 was set to the deepest level of granularity again (sentence level—“5”). Consequently, only those finite elements (sentences) 166 that included the Japanese character were revealed in the hierarchical display.

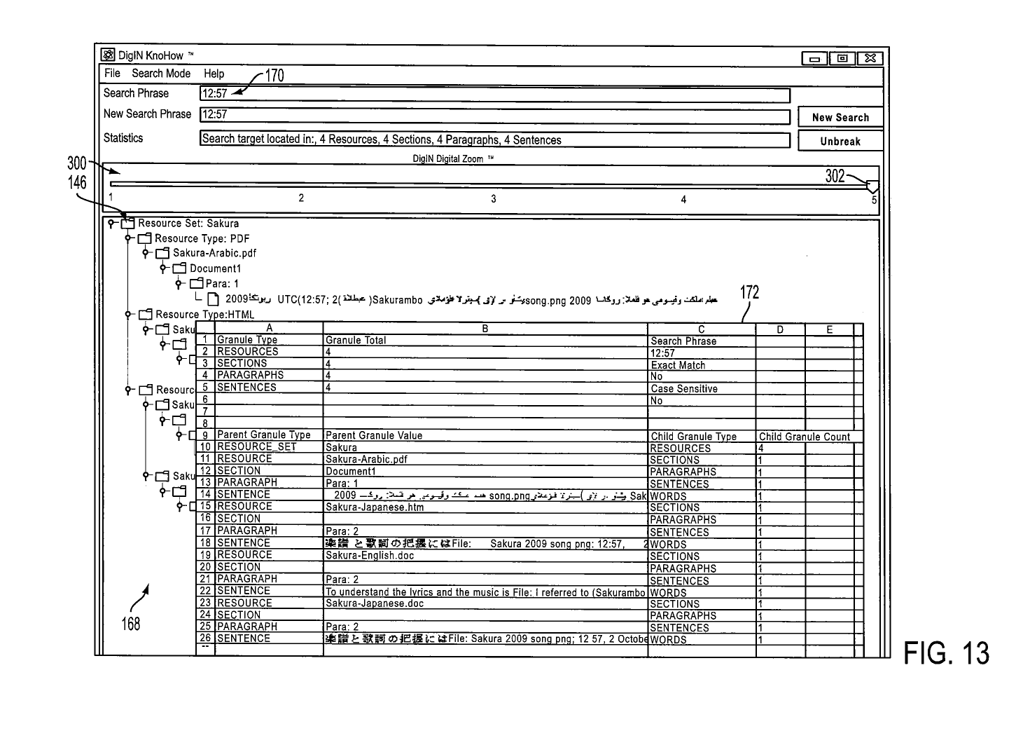

FIG. 13 is an illustration 168 for search results taken again from the “Sakura” resource set 146 of FIG. 8, where the granularity zoom slider 302 on the slider bar 300 was set to the deepest level of granularity (sentence level—“5”) across the entire resource set; and where the search results for the query “12:57” 170 are revealed. Also illustrated is a spreadsheet representation of the statistical results of the same search in window 172. As shown in the spreadsheet output, four resources were identified as containing “12:57”; four total sections were identified as containing “12:57” (one in each resource); four total paragraphs were identified as containing “12:57” (one in each resource/section); and four total sentences were identified as containing “12:57” (one in each resource/section/paragraph). Below that, the specific resources, sections, paragraphs and sentences are identified for each hit in the search; along with numerical results to the right to quantify the frequency of parent-child relationships within and between granularity levels for a given search query 26.

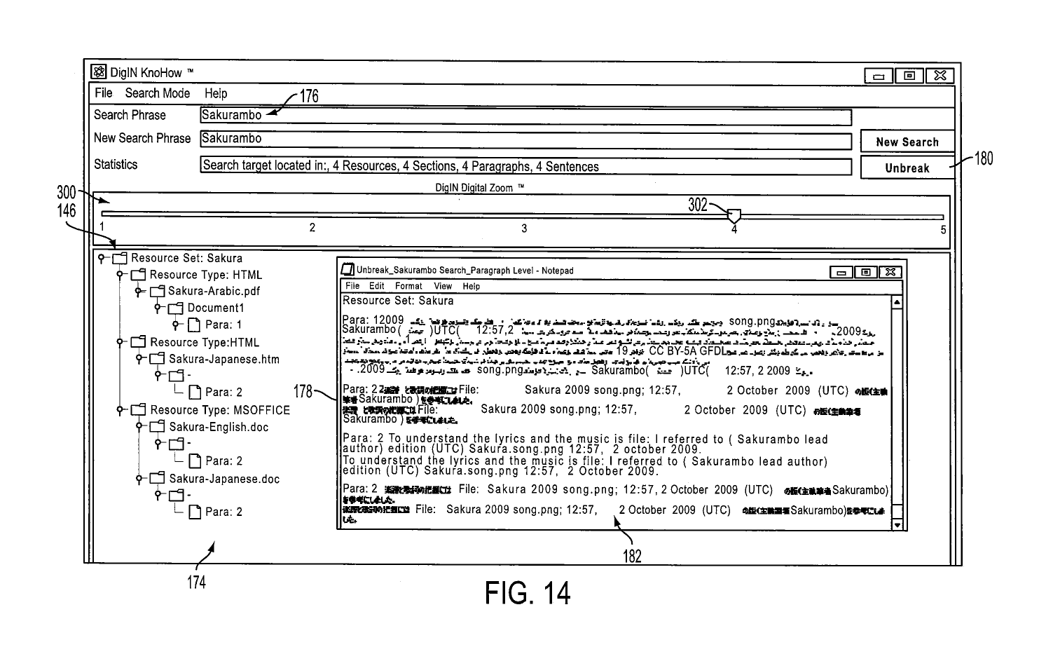

FIG. 14 is an illustration 174 for search results taken again from the “Sakura” resource set 146 of FIG. 8, where the granularity zoom slider 302 on the slider bar 300 was set to the paragraph level “4” of granularity across the entire resource set; and where the search results for the query “Sakurambo” 176 are revealed. Also illustrated is the Notepad output 178 of the unbreak module's compilation of the paragraphs (resulting from activation of the “Unbreak” button 180 on the interface), in which “Sakurambo” appears, are combined into a single document 182.

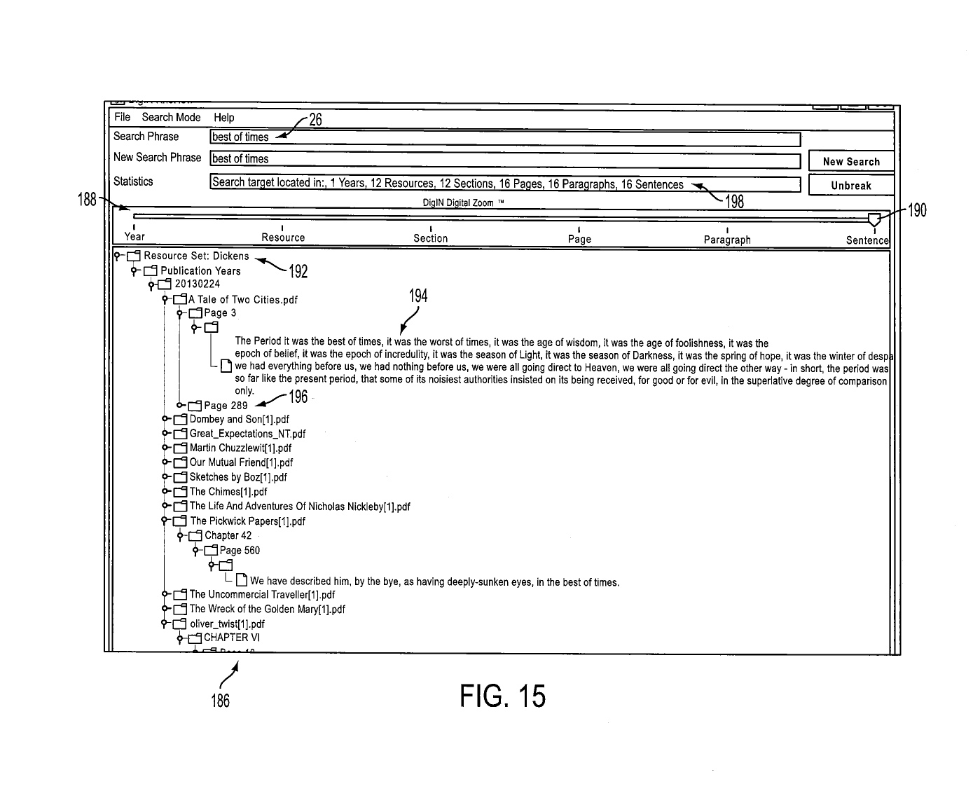

FIG. 15 provides an example hierarchical display output 186 utilizing a granularity zoom interface (referred to in the figure as the DigIN Digital Zoom™) based on a tailored rule set for the break module 10 for set of resources with implicit rules (represented by pdf files) that have consistent structural boundaries or patterns. The display output screen includes a granularity zoom interface 188 in the form of a slider bar, in which a user manipulates a slider 190 along the bar to select a desired level of granularity for display from the most shallow “YEAR” to the deepest “SENTENCE.” In the example shown in FIG. 15, the resource set 192 (e.g., Dickens) of resources (e.g., the 55 books authored by Charles Dickens) to illustrate how the DigIn Digital Zoom™ enables the user to expand and collapse a concept space across levels of granularity that are defined specifically and objectively for a search query 26 (e.g., “best of times”). In addition, this example illustrates how the invention can be used to discover knowledge and be surprised by a previously unknown result. In this example, it was well known that the phrase “best of times” (Search Mode on exact match) occurs in the first paragraph 194 of A Tale of Two Cities, however, it was not known that the phrase occurred twice in this book, again on page 289 (see numeral 196). Moreover, it was surprising to discover that this phrase also was found in 12 resources (e.g., books) among 12 sections (e.g., chapters) on 16 pages in 16 paragraphs with 16 sentences as the lowest level of granularity (see numeral 198). In this example, the publication year refers to the date when the resource set 192 was produced, containing all of the indexed finite elements (i.e., 433,507 sentences from Dickens' 55 books) that were broken apart based on a set of rules (e.g., that defined a section boundary by a line beginning with “Chapter” with blank lines before and after) from the set of resources. Since “Chapters” were not labeled in the pdf file for A Tale of Two Cities, sections were not broken apart in this book.

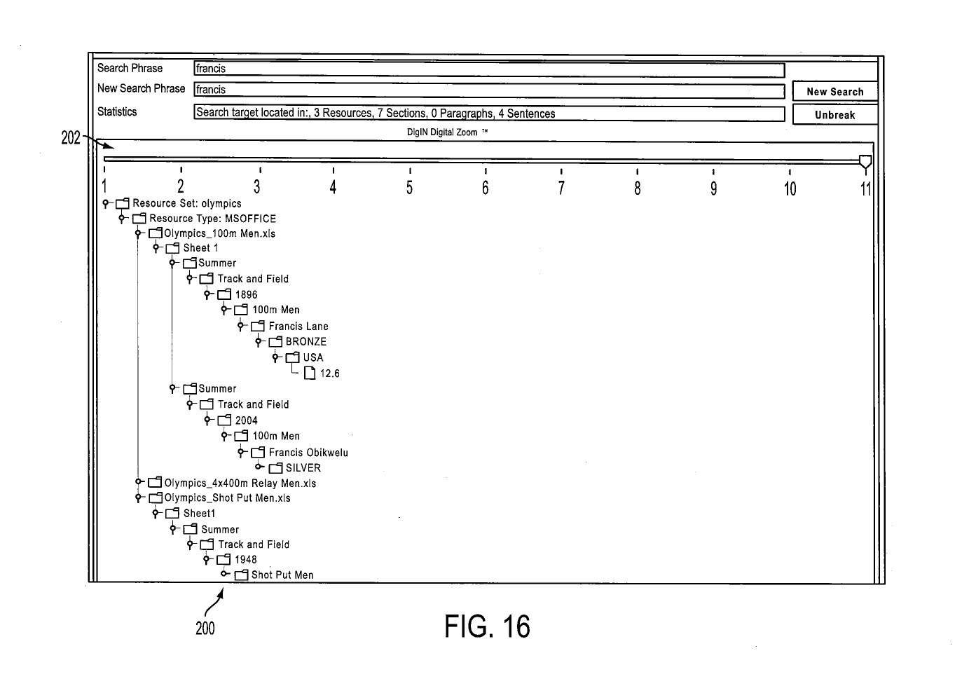

FIG. 16 provides an example hierarchical display output 200 utilizing a granularity zoom interface (referred to in the figure as the DigIN Digital Zoom™) 202 based on a tailored rule set for the break module 10 to operate across set of resources that have consistent structural boundaries or patterns. Example of integration among 83 spreadsheets, representing the statistics of Olympic track and field events from the years 1896 to 2008. For the search term “Francis,” results were in found in 3 resources (spreadsheets) and 4 ‘sentences’ (cells) across ten columns of data that were expanded with the DigIn Digital Zoom™ with some of the hierarchy levels selectively collapsed. Statistical references to 7 ‘sections’ and 0 ‘paragraphs’ were artifacts of the generic break model that was applied to this set of resources. It is noteworthy that this invention may provide an automatic and objective solution to integrate diverse spreadsheets for the purpose of discovering and analyzing relationships among their cells, rows and columns.

While the systems and methods described herein constitute exemplary embodiments of the current disclosure, it is to be understood that the scope of the claims are not intended to be limited to the disclosed forms, and that changes may be made without departing from the scope of the claims as understood by those of ordinary skill in the art.

What is claimed is:

1. A system for retrieving information from an informational resource, comprising:
one or more computer processors;
at least one display device operatively coupled with the one or more processors;
at least one searchable database, the at least one database including at least a portion of an informational resource broken into a plurality of discrete finite elements and a respective plurality of categorical tag respectively describing content for each of the plurality of discrete finite elements, the informational resource including at least three of levels of granularity for the information, from a shallow level of granularity to a deep level of granularity; and
at least one non-transitory memory containing software for executing by the one or more computer processors, the software including instructions for:
(a) receiving a search query and a level of granularity for display;
(b) searching the searchable database for relevant finite elements associated with the search query to identify a plurality of relevant discrete finite elements satisfying the search query;
(c) on the display device, displaying identifying information pertaining to the relevant, discrete finite elements in a hierarchical display, the identifying information being displayed at the received level of granularity for display;
(e) displaying an interface on the display device allowing a user to change the level of granularity for display;
(f) receiving from the interface a new selected level of granularity for display;
(g) on the display device, displaying identifying information pertaining to the relevant, discrete finite elements in a hierarchical display, the identifying information being displayed at the new level of granularity for display.

2. The system of claim 1, wherein the identifying information pertaining to the relevant, discrete finite elements includes information to other related, discrete finite elements.

3. The system of claim 2, wherein the other related, discrete finite elements are determined based upon information contained within the categorical tag of the relevant discrete finite element.

4. The system of claim 1, wherein the at least three levels of granularity include sentence level, paragraph level and document level.

5. The system of claim 1, wherein the at least three levels of granularity include sentence level, paragraph level, page level, at least one of section and chapter level, and resource level.

6. The system of claim 1, wherein the at least three levels of granularity include at least one of: (a) components of DNA sequence data, (b) sections of financial reports, (c) cells of a spreadsheet, and (d) a satellite name, a sensor system and timing information.

7. (canceled)

8. (canceled)

9. (canceled)

10. The system of claim 1, wherein the at least three levels of granularity include any parent, child and grandchild relationship between components of the informational resource.

11. The system of claim 1, wherein the software further includes instructions for:
(h) receiving a selection of at least one of the displayed relevant finite elements;
(i) constructing a new information resource from selected relevant finite element combined with other finite elements associated with the selected relevant finite element.

12. The system of claim 11, wherein the other finite elements associated with the selected relevant finite element are determined based upon information contained within the categorical tag of the relevant finite element.

13. The system of claim 11, wherein the other finite elements associated with the selected relevant finite element are determined based upon positional information contained within the categorical tag of the relevant finite element.

14. The system of claim 11, wherein the other finite elements associated with the selected relevant finite element are the additional relevant finite elements.

15. The system of claim 11, wherein the software further includes instructions for (j) generating numeric data about the frequency of parent-child relationships within and between different levels of granularity that is captured within the informational resource.

16. The system of claim 1, wherein the interface is at least one of: a slider-bar interface, a touch-screen interface, a color continuum interface, a rotational interface and an acoustic interface.

17. (canceled)

18. (canceled)

19. (canceled)

20. (canceled)

21. The system of claim 1, wherein:
the system is a hand-held and portable computing device; and
the at least one searchable informational resource and software are part of an application loaded onto the hand-held and portable computing device.

22. A non-transitory computer readable medium having instructions for causing a computer to execute process steps for searching a digital information resource, the process steps comprising:
(a) dividing the digital information resource into a plurality of discrete finite elements by applying a rule set, wherein the rule set defines a dividing level of granularity, upon which the dividing step will occur, and wherein the rule set further defines a plurality of shallower levels of granularity for the digital information resource;
(b) associating each discrete finite element with a tag, wherein the tag comprises the dividing level of granularity and a contextual identification component, wherein the contextual identification component uniquely identifies a contextual position of the discrete finite element in the digital resource;
(c) generating a searchable database, wherein the searchable database comprises a database record for each discrete finite element, wherein each database record includes at least some content of the finite element;
(d) receiving input data from a user, wherein the input data comprises at least one search parameter and an initial level of granularity for display for the at least one search parameter;
(e) searching the searchable database using the at least one search parameter received in the receiving step; and
(f) displaying search results in a display format reflecting the initial level of granularity for display received in the receiving step.

23. The non-transitory computer readable medium of claim 22, wherein the processing steps further comprise:
(i) receiving a subsequent input data from the user, wherein the subsequent input data comprises a subsequent level of granularity for display; and
(ii) displaying the search results in a display format reflecting the subsequent level of granularity for display.

24. The non-transitory computer readable medium of claim 22, wherein displaying step (f) further comprises:
(i) calculating a number of deeper discrete finite elements containing search results for each finite element displayed, wherein the deeper discrete finite elements are discrete finite elements that have a level of granularity deeper than the level of granularity for display; and
(ii) displaying the number of deeper discrete finite elements containing search results for each discrete finite element in the display format.

25. The non-transitory computer readable medium of claim 22, wherein the processing steps further comprise:
(i) receiving a subsequent input data from a user, wherein the subsequent input data comprises a selected discrete finite element and a deeper level of granularity; and
(ii) adjusting the display format for the selected discrete element to display deeper search results, wherein the deeper search results have a level of granularity deeper than the initial level of granularity for display.

26. A system for retrieving information from an informational resource, comprising:
one or more computer processors;
at least one display device operatively coupled with the one or more processors;
at least one non-transitory memory containing software for executing by the one or more computer processors, the software including:
(a) a break module, configured to break an informational resource into a plurality of finite elements and create a categorical tag for each finite element, the categorical tag including data pertaining to a content of the finite element and a level of granularity for the information, from a shallow level of granularity to a deep level of granularity;
(b) an index module, configured to create a searchable database having a plurality of database records, each database record corresponding to at least one of the finite elements and including at least a portion of data contained in or pertaining to the finite element;
(c) a search module, configured to compare a search query with each of the database records and determine which, if any, of the database records are relevant database records; and
(d) an integration module, configured to display relevant database records in a hierarchical structure and calculate the number of finite elements within and between each level of granularity for graphical and statistical analysis.

27. The system of claim 26, wherein the integration module is configured to receive a level of granularity for display from the user and to display search results in a display format reflecting the level of granularity for display.

28. The system of claim 27, wherein the integration module is further configured to enable a user to expand a selected finite element to reveal additional search results at a deeper level of granularity.

29. The system of claim 28, wherein the integration module is further configured to enable a user to collapse branches of the hierarchical structure to a shallower level of granularity.

30. The system of claim 27, wherein the information resource is a plurality of information resources.

31. (canceled)

32. The system of claim 27, wherein the user selects a level of granularity by using at least one of: a slide-bar, a menu, a color continuum interface, a rotational interface, an acoustic interface, a touch screen interface and a voice recognition interface.

33. (canceled)

34. (canceled)

35. (canceled)

36. (canceled)

37. (canceled)

38. The system of claim 26, wherein the software further includes an analytics module configured to generate numerical data from the informational resource based, at least in part, upon frequency of parent-child relationships within and between components of the informational resource that can be described objectively in relation to at least one of structural boundaries and patterns.
